(19) United States
(12) Patent Application Publication
(10) Pub. No.: US 2007/0226088 A1
(43) Pub. Date: Sep. 27, 2007

(54) ITEM MANAGEMENT SYSTEMS AND ASSOCIATED METHODS

(75) Inventors: Michael D. Miles, Portland, OR (US); Ron Wiener, Portland, OR (US); Brett R. Prochaska, Portland, OR (US)

Correspondence Address: PERKINS COIE LLP;PATENT-SEA, P.O. BOX 1247, SEATTLE, WA, 98111-1247, US

(73) Assignee: Earth Class Mail Corporation, Kirkland, WA (US)

(21) Appl. No.: 11/694,751

(22) Filed: Mar. 30, 2007

Related U.S. Application Data
(63) Continuation-in-part of application No. 11/253,091, filed on Oct. 17, 2005.
Application No. 11/253,091 is a continuation-in-part of application No. 11/195,491, filed on Aug. 1, 2005.
(60) Provisional application No. 60/619,367, filed on Oct. 15, 2004.
(60) Provisional application No. 60/626,571, filed on Nov. 9, 2004.
(60) Provisional application No. 60/787,271, filed on Mar. 30, 2006.
(60) Provisional application No. 60/787,319, filed on Mar. 30, 2006.
(60) Provisional application No. 60/787,321, filed on Mar. 30, 2006.

(51) Int. Cl. G06Q 10/00

(52) U.S. Cl. 705/28

(57) ABSTRACT

The present invention is directed generally toward item management systems and associated methods. Aspects of the invention are directed toward receiving items, inducting the items into the item management system and storing the items. In certain embodiments, inducting the item can include imaging at least a portion of the item and providing that image to a remote user. Other aspects of the invention include retrieving the items form storage and processing the items. In selected embodiments, processing an item can include processing the item in accordance with instructions provided by a remote user. In certain embodiments, at least some of the items that have been processed can then be returned to storage. Still other aspects of the invention can include monitoring various portions of the item management process. In selected embodiments, various aspects of the invention can be automated and/or computer controlled. Additionally, various aspects of the invention can allow non-uniform items to be stored in a uniform structure.

### CROSS-REFERENCE TO RELATED APPLICATIONS

This non-provisional application is a continuation-in-part of U.S. patent application Ser. No. 11/253,091, entitled ITEM MANAGEMENT SYSTEMS AND ASSOCIATED METHODS, filed Oct. 17, 2005, which is fully incorporated herein in its entirety by reference, and which is a continuation-in-part of U.S. patent application Ser. No. 11/195,491, entitled SYSTEM AND METHOD FOR PROVIDING A VIRTUAL MAILBOX, filed Aug. 1, 2005, which is fully incorporated herein in its entirety by reference, and which claims priority to U.S. Provisional Patent Application No. 60/592,648, filed Jul. 30, 2004, U.S. Provisional Patent Application No. 60/619,367, filed Oct. 15, 2004, and U.S. Provisional Patent Application No. 60/626,571, filed Nov. 9, 2004, all of which are incorporated herein in their entirety by reference. Additionally, this non-provisional application claims the benefit of and priority to U.S. Provisional Patent Application No. 60/787,271, entitled AUTONOMOUS MAIL DISPENSING KIOSK, filed Mar. 30, 2006, U.S. Provisional Patent Application No. 60/787,319, entitled DOCUBOTIC SORTERS FOR UNIVERSAL SERVICE PROVIDERS (NATIONAL POST OFFICES), filed Mar. 30, 2006, and U.S. Provisional Patent Application No. 60/787,321, entitled DOCUMENTARY RETROACTIVE VIDEO EDITING AND SURVEILLANCE SYSTEM, filed Mar. 30, 2006, each of which is incorporated herein in its entirety by reference thereto.

### TECHNICAL FIELD

Embodiments of the present invention relate to item management systems and associated methods, including automated remote control document management systems.

### BACKGROUND

Sending, transporting, receiving, reviewing, copying, storing, retrieving, and destroying paper documents is time consuming and costly for individuals and businesses. Additionally, the destruction and disposal of paper documents can negatively impact the environment unless these paper documents are recycled, which in itself can be time consuming and expensive. Regulatory requirements (Sarbanes-Oxley, HIPPAA, etc.) continue to add to the complexity and cost of managing paper documents. The “paperless office” concept has been with us since the mid-1970's, but has for various reasons not fully come to fruition. Accordingly, there is still a need to physically store paper documents, as well as other items, in a manner such that the documents can be tracked, retrieved, reviewed, replaced in storage, and/or destroyed.

Another problem with paper documents is that they typically require a person reviewing the documents to be physically located with the documents. For example, if someone has more than one residence, has more than one office, and/or spends a significant amount of time traveling, it can be difficult to keep track of the mail or other documents that get delivered to various locations. This problem is often solved by tasking someone at each of the various locations to pickup, review, and/or forward the mail or other documents delivered to the associated location. This solution can be inefficient and costly, and in some cases can delay the receipt of time sensitive information.

### BRIEF DESCRIPTION OF THE DRAWINGS

FIG. 1 is a schematic flow chart showing an item management process in accordance with an embodiment of the present invention.

FIG. 2 is a partially schematic illustration of an item with an identification tag in accordance with certain embodiments of the invention.

FIG. 3 is a partially schematic illustration of an item management system in accordance with embodiments of the present invention.

FIG. 4 is a schematic block diagram that illustrates a computing environment suitable for implementing or aiding various portions of item management processes in accordance with embodiments of the invention.

FIG. 5 illustrates a computer display through which a user can interface/interact with an item management process that includes a remote document process in accordance with embodiments of the present invention.

FIG. 6 illustrates another computer display through which a user can interface/interact with an item management process that includes a remote document process in accordance with other embodiments of the invention.

FIG. 7 is a schematic flow chart showing a one-touch induction process in accordance with certain embodiments of the invention.

FIG. 8 is a schematic flow chart showing a two-touch induction process in accordance with other embodiments of the invention.

FIG. 9 is a partially schematic illustration of a storage center of the item management system in accordance with certain embodiments of the invention.

FIG. 10 is an isometric illustration of an individual storage rack of a storage center configured to store multiple different types of containers that contain one or more documents in accordance with various embodiments of the invention.

FIGS. 11-13 are isometric illustrations of a rack with a robotic manipulator and portions of the rack used to insert containers that contain one or more documents into the rack, remove the containers from the rack, and manipulate the containers relative to the rack in accordance with other embodiments of the invention.

FIG. 14 is an isometric illustration of a portion of a storage center with containers attached to one or more conveyor systems in accordance with certain embodiments of the invention.

FIG. 15 is an isometric illustration of a chute system used to transfer items in the storage center shown in FIG. 14 in accordance with certain embodiments of the invention.

FIG. 16 is an isometric illustration of a portion of a storage center with a chute system for transferring containers between one portion of the storage center and another in accordance with certain embodiments of the invention.

FIG. 17 is a schematic flow chart showing a scanning process performed at a processing center in an item management system in accordance with embodiments of the invention.

FIG. 18 is an isometric illustration of a manual induction station in accordance with certain embodiments of the invention.

FIG. 19 is a schematic flow chart showing a process of sorting mail items at a postal facility in accordance with certain embodiments of the invention.

FIG. 20 is a schematic flow chart showing a process for delivering mail items at a facility in accordance with selected embodiments of the invention.

FIG. 21 is a schematic flow chart of an item tracking method in accordance with certain embodiments of the invention.

FIG. 22 is a partially schematic illustration of video tracking arrangement suitable for use in tracking an item in accordance with selected embodiments of the invention.

### DETAILED DESCRIPTION

The present disclosure describes item management systems and associated methods in accordance with certain embodiments of the present invention. Several specific details of the invention are set forth in the following description and the Figures to provide a thorough understanding of certain embodiments of the invention. One skilled in the art, however, will understand that the present invention may have additional embodiments, and that other embodiments of the invention may be practiced without several of the specific features described below.

Introduction

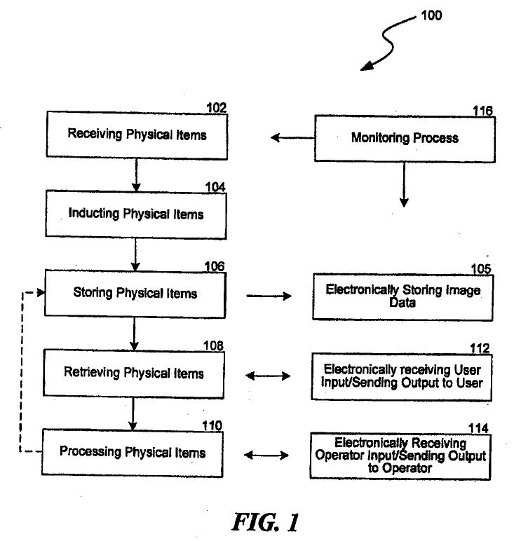

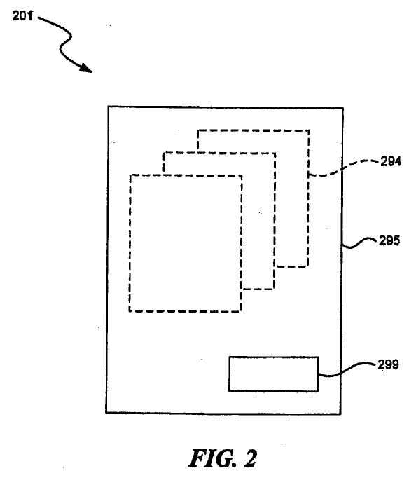

The present invention is directed generally toward item management systems and associated methods. As shown in FIG. 1, selected aspects of the invention are directed toward an item management process 100 that includes receiving physical items (process portion 102), inducting the items, including imaging the items into the item management system (process portion 104), electronically storing image data related to each item (process portion 105), and storing the physical items in a selected and identified location (process portion 106). The items can include any physical item including a single piece of paper, an envelope, a piece of mail, a magazine, a group of documents (e.g., a letter with multiple pages), CD or DVD, a group of CD/DVDs, a package, a book and/or other physical items. In selected embodiments, the items have non-uniform shapes and sizes relative to each other. In certain embodiments, inducting the item can include gathering information about the item, assigning or applying a unique identifier (e.g., a code, tag, a marking, or other identification), scanning or imaging at least a portion of the item, and/or preparing the item for storage. Applying the identifier can include any identification arrangement including physically configuring the item for identification or attaching a material to the item. For example, as shown in certain embodiments a piece of paper can have symbols or a code printed onto the paper or physically pressed or crimped into the paper itself so that the paper can later be identified. In other embodiments a radio frequency identification tag, a bar code, one or two dimensional symbology, and/or other unique identifier can be coupled to the item. FIG. 2 is a partially schematic illustration of an item 201 with an identifier 299 in accordance with certain embodiments of the invention. In FIG. 2, the item 201 includes packaging 295 (e.g., an envelope or pouch) and content 294 (e.g., documents inside of the packaging). In other embodiments, the item 201 can have other arrangements and/or the identifier can be applied to other portions of the item 201.

Referring back to FIG. 1, other aspects of the invention can include retrieving the inducted items from storage (process portion 108) and processing the items (process portion 110) in accordance with instructions for each of the items. In certain embodiments processing the item (process portion 110) after retrieval or induction can include sending the physical item to a recipient or user (e.g., an entity including a person and/or organization remote from the storage center), forwarding the physical item to another remote entity or location, scanning one or more portions of the item to provide a visual image of the item's portion to a remote recipient, archiving the item, shredding the item, disposing of the item, and/or recycling the item. In selected embodiments, at least some of the items that have been processed can be returned to storage (process portion 106).

In certain embodiments, the item management process can also include receiving user input from a remote location and/or sending output to the remote user (process portion 112). Additionally, in selected embodiments the item management process can include receiving operator input and/or sending output to the operator (process portion 114). In various embodiments, the operator can be on-site at the item management center or at a remote location.

For example, in selected embodiments if the item is a piece of mail, all or a portion of the envelope is scanned during induction, and that image of the envelope can be electronically sent to a remote user, such as via a computer network. The remote user can then provide instructions on how the piece of mail should be processed. Additionally, in certain embodiments a remote user can set up rules for how certain items should be handled or processed in the item management process. Similarly, in certain embodiments the operator (e.g., an entity) can receive information regarding selected items (e.g., items that are difficult to identify during the induction process) and provide input on how to handle the selected item in the item management process. In still other embodiments, the item management process can also include one or more monitoring processes that can be used to monitor substantially all or various portions of the item management process (process portion 116). In yet other embodiments, various aspects of the invention can be automated and/or computer controlled.

The item management process 100 can be used to accomplish various tasks. For example, various aspects of the invention allow a non-uniform item to be stored in a uniform structure. For instance, in certain embodiments, items having non-homogeneous physical characteristics or dimensions (e.g., outer shapes and sizes) to be stored in carriers or rack locations having substantially homogeneous dimensions (e.g., outer shapes and sizes). In selected embodiments, the uniform structures (e.g., carriers) containing the items can be manipulated manually or automatically during selected process steps. Other aspects can allow the storage and/or retrieval of specifically identified and discrete items in a specific sequence. Still other aspects of the invention can allow the physical items to be received at one location, remotely reviewed, and/or processed in accordance with instructions provided by a remote user or an operator. Various embodiments of the item management process 100 can be used to form various systems including document control or storage systems and/or other item control systems (e.g., CD/DVD data storage systems, CD/DVD rental services, book lending services and/or other goods-related systems and services).

In selected embodiments, the item management process 100 can also be used in a remote mail service in accordance with instructions from the remote user. For example, in certain embodiments a remote mail service can allow a user to have mail (e.g., U.S. Postal mail and/or internal company mail) delivered to a specified location remote from the user's location, the mail can go through the receiving and induction process, and the remote user can then review an image of at least a portion of each mail item (e.g., the envelope or package), such as over the internet or other computer network. The remote user can provide instructions via the computer network on how the mail should be processed at the mail processing location. For example, the user can have the entire mail item (e.g., an envelope and its contents) scanned or otherwise imaged, and the image sent to the remote user via the computer network for review. The user can provide instructions to have the mail item sent to another remote entity or location, recycled, destroyed, shredded, or archived. In selected embodiments, the remote user can set up rules or instructions in advance via a user interface available over the network so that certain mail items are automatically processed in accordance with the instructions when they are received and inducted into the system at the mail processing location.

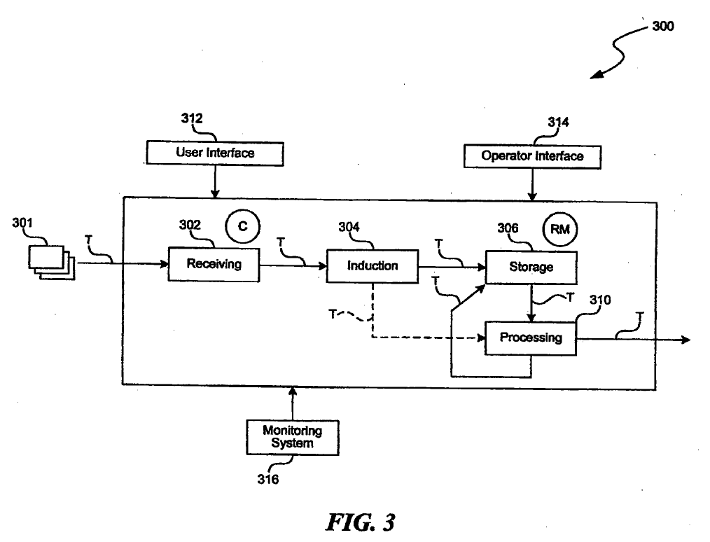

FIG. 3 is a partially schematic illustration of an item management system 300 in accordance with various embodiments of the invention. The item management system 300 located remote from the user can receive physical items 301 at a receiving station 302. The receiving station 302 can have a cache C for holding items 301 until each of the items can complete the receiving process and/or the item can be moved to an induction center 306. The induction center 306 can perform the induction process described above. Additionally, after at least a portion of the item is imaged during the induction process, the image of the item and/or at least a portion of the information gathered about the item can be sent to a remote user via the computer network and presented to the remote user via the user interface 312. The remote user can also provide input, such as instructions, to the item management system 300 via the user interface 312, for example, to provide instruction for processing each item. Similarly, the item management system 300 includes an operator interface 314 through which an on-site or remote operator can receive output (e.g., information) from the item management system 300 and through which the operator can provide input (instructions) to the item management system 300 for processing the item or performing other related tasks. In selected embodiments, the operator can receive output and provide input via a network and the operator interface.

In certain embodiments, the induction process includes receiving the item, identifying one or more markings (e.g., an address, symbology, a code, or other information on the item), and analyzing the markings to determine which remote user(s) is/are associated with the particular item. For example, in a document management system there may be multiple remote users or entities associated with a single item. In one embodiment, an Optical Character Recognition (OCR) process is used to “read” the marking on the item so the item can be associated with the proper remote user(s). Other embodiments can use other systems, such as bar code systems, symbol-reading systems, radio frequency identification systems, or other identification systems to accurately determine which remote user(s) is/are associated with the item. Accordingly, each item can be processed in accordance with the instructions from the correct remote user(s), as discussed in greater detail below.

After the induction process is completed and the item is associated with the correct remote user(s), the physical item can be transferred to a storage center 306. In one embodiment, the location of each item in the storage center and to/from the storage center is tracked via the identifier on each item. The storage center 306 can store the item so that the item can be quickly and accurately identified, stored, moved, and/or retrieved because the location of each item is always known by using the identifier to track the exact location of the item (e.g., via a computing system) in the storage center. For example, the identifier may be a bar code, and each time the item is moved, the bar code is scanned and its location is correlated with other bar codes associated with each location in the storage center. Additionally, in certain embodiments where the items have different physical parameters (e.g., shapes, sizes, and weight) the storage center can be configured to store each non-uniform item in a uniform structure. In certain embodiments, the item and the uniform structure are then moved together as a unit within the storage center. For example, in certain embodiments of a remote mail center where different mail items have different sizes and shapes, each mail item can be placed in a cassette or other type of storage container. The outer portions of the cassettes are uniform in shape and size so that they can be manipulated and stored in any one of multiple positions in a rack system or other storage structure, as discussed in greater detail below.

Additionally, in selected embodiments the cassettes and/or the rack system can have unique identifying features to aid in tracking and retrieving a particular cassette and its item at a later time for further processing. For example, in certain embodiments the cassette and storage areas in the rack system each have unique identifiers. The identifier on an item can be matched or otherwise associated with an identifier on a cassette, and the identifier on the cassette is matched or otherwise associated with the identifier of the storage area in the rack system. When a cassette and item are moved, the cassette identifier is re-associated with the identifier at the new location. Accordingly, the location of each item in the system is always tracked, known, and the item can be quickly retrieved from the storage center 306 for processing at any time. Additionally, in selected embodiments the storage process can include re-arranging or organizing items in the rack system after they have been stored to expedite the retrieval process. For example, in a remote mail system, various mail items in their respective cassettes (when used) can be re-arranged or organized in a rack system (e.g., moved from one location in the rack system to another) so that the item, which are likely to retrieved at the same time are physically proximate to each other. In certain embodiments, various transport mechanisms (e.g., conveyor systems) and/or one or more robotic manipulators RM can be used to move the items throughout the storage center, for example, during initial storage, re-storage (e.g., an item returned after processing), organization, and/or retrieval.

Once an item is retrieved from the storage center 306 it can move to a processing center 310. At the processing center 310, the item can undergo various types of processing, including scanning or imaging (e.g., scanning the entire content of the item for transmission to the remote user or other entity via the computer network), preparing the item for physical shipment to the remote user or other entity, destroying the item, recycling the item, and/or archiving the item. After the processing steps are completed, the remaining items can be returned to the storage center. For example, in certain embodiments an item being archived or scanned during processing might be returned to the storage center 306 after the processing is complete. In selected other embodiments, archived items can be stored in a designated portion of the storage center 306, because those archived items are not expected to be accessed in the near term.

In other embodiments, processing can simply include the item moving through the processing station. For example, in certain embodiments multiple items are removed from the rack system in a group and as the group of items move through the processing center 310, while other items are scanned, archived, sent out of the system, and/or destroyed, some of the items are simply returned to storage in a selected location in the rack system. As indicated above, the specific location of each item is tracked via its identifier as the item moves within the processing center 310 or the storage center 306. In certain embodiments, items move to the processing center 310 after induction without passing through the storage center 306. For example, as discussed above, in a remote mail system the remote user or the operator can set up rules in advance such that certain items identified during the induction process are sent directly to processing and recycled, queued for disposal, sent to the remote user, or another entity.

The items 301 can be moved throughout the item management system 300 (e.g., between the various stations) via transport mechanisms T and/or manual labor. The transport mechanisms T can have various transport elements including conveyors, carts, robotic manipulators, carriers or pallets, cassettes and/or storage units. In various embodiments, the transport mechanisms T can be manually operated, partially automated, or fully automated. In certain embodiments, all or a portion of the transport mechanisms T can be computer controlled. Any of the various stations in the item management system 300 can also include one or more transport mechanisms T as needed for each station, for example, one or more robotic manipulators that interact with carriers on an adjacent conveyor system. Additionally, any of the various stations in the item management system 300 and/or portions of the transport mechanism T can also include a cache C, similar to that discussed above with reference to the receiving station 302 to temporarily hold the items until they can be further processed. The caches C can also include unique identifiers that can be associated with the identifier of each item to accurately track the location of each item. It is understood, that in certain embodiments various elements of each of the various centers in the item management system can physically overlap.

In certain embodiments, the item management system 300 can also include a monitoring arrangement or monitoring system 316 to monitor various portions of the item management system 300 or item management process. For example, the monitoring system 316 can provide tracking, observation, and location information of the items while they are in the item monitoring system 300. The monitoring system 316 can be completely manually operated, partially automated, or fully automated. In certain embodiments, at least a portion of the monitoring system 316 can be computer implemented and/or computer aided. In selected embodiments, the monitoring system 316 can include a video camera or video system to visually record the items in various portions of the item management system 300 or item management process. In other embodiments, the system can include other electronic monitoring devices, for example, still cameras, Radio Frequency Identification (RFID) receivers/readers, and barcode reading devices. Additionally, in some embodiments monitoring can be accomplished remotely. For example, when using a video system to monitor a portion of the item management process, the visual images can be sent via a network to a remote location where the images can be stored and/or reviewed.

The information collected by the monitoring system 316 can be useful for many purposes. For example, in certain embodiments the monitoring system 316 can provide information in the event an item does not arrive at its intended location or if the item is a sealed pouch containing confidential information the monitoring system can provide an indication that the contents may have been accessed by unauthorized observers. In selected embodiments, a portion of the information collected by the monitoring system 316 can be provided to the owner, recipient, or other authorized entity associated with a specific item to provide a record of the events that transpired during the handling of the specific item. In other embodiments, information collected by the monitoring system 316 can be examined by an operator and the operator can provide input to the system via the operator interface 314 based on the information. For example, in certain situations, an operator can provide input to correct a problem that is observed via the monitoring system 316. The monitoring system 316 can also act as a security system that monitors the on-site operations and/or operators as items are moved through and between various centers.

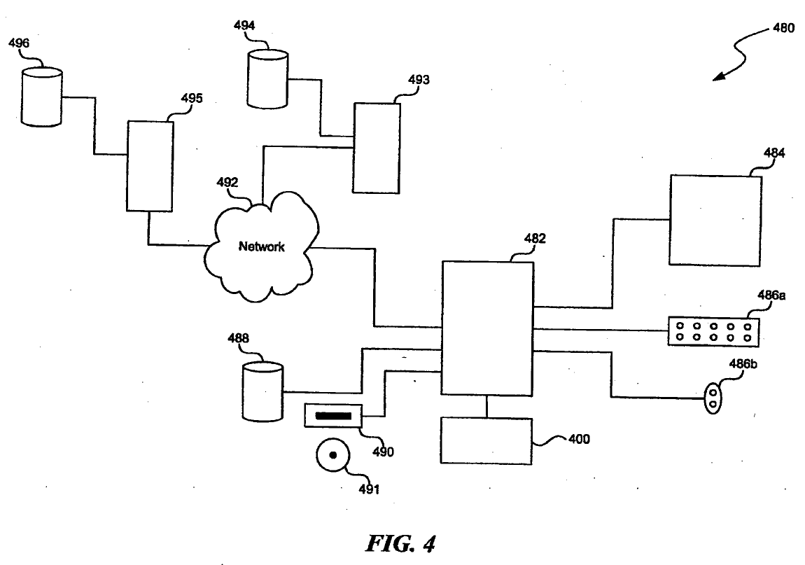

As discussed above, portions of the item management system can be computer implemented, controlled, or aided. Additionally, various computing systems can be used to interface with one or more portions of the item management system. FIG. 4 is a block diagram that illustrates a computing environment suitable for implementing or aiding various portions of item management processes in accordance with embodiments of the invention. The computing environment 480 can be operably coupled to, or integral with, at least a portion of an item management system 400, similar to the item management system described above with reference to FIG. 3. The computing environment 480 can include a computing or computer system 482 that can be operably connected or coupled to a display 484 and one or more input devices, for example, a keyboard 486a and a pointing device 486b (e.g., a mouse). Additionally, the computer system 482 can communicate with one or more storage devices (e.g., a hard drive 488 with one or more databases) and one or more devices 490 for reading other types of computer readable mediums (e.g., devices for reading disks 491).

The computer system 482 can also communicate via a network 492 (e.g., the Internet) with other devices or systems. For example, in the illustrated embodiment the computer system 482 can communicate with a user computer system 493, a user database 494, an operator computer system 495, and/or an operator database 496 via the network 492. In other embodiments, the computing environment 480 can have other arrangements, including more, fewer, and/or different components.

For example, the computing device or environment on which the system is implemented may include a central processing unit, memory, additional input devices (e.g., keyboard, pointing devices, and/or other sensors), other output devices (e.g., display devices), and other storage devices (e.g., disk drives). The memory and storage devices can include computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Portions of the item management system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems can include cell phones, personal digital assistants, smart phones, personal computers, programmable consumer electronics, digital cameras, and so on.

Furthermore, various portions of the system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

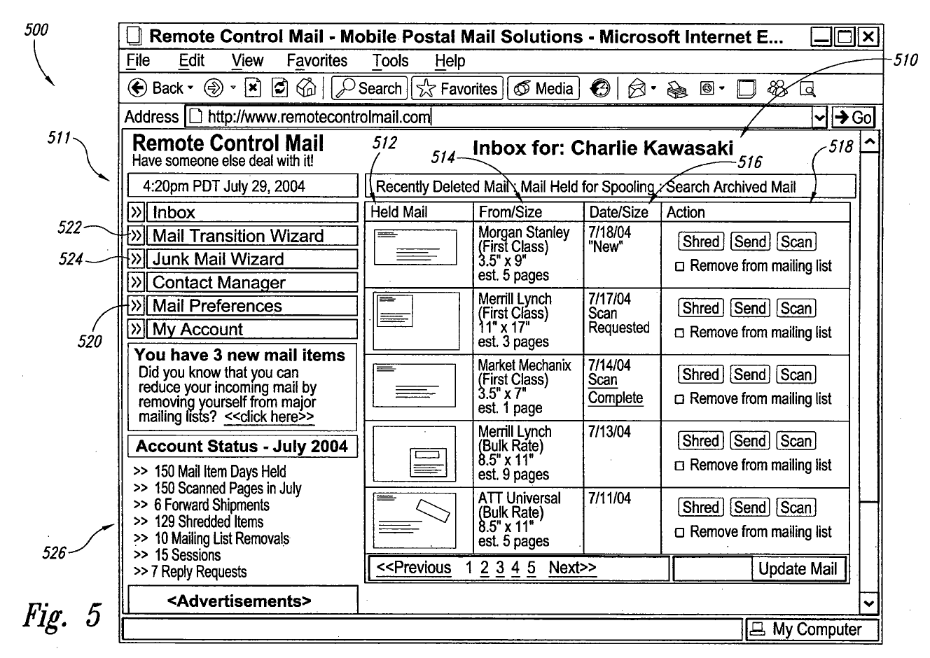

FIG. 5 illustrates a computer display 500 through which a user can interface/interact with an item management process that includes a remote mail process in accordance with embodiments of the present invention. In FIG. 5, the user interface display 500 is accessed through a network (e.g., the internet). The display can include an inbox 510, multiple links 511 to various other displays associated with the mail process, and other information 526.

In the illustrated embodiment, the inbox includes an image section 512, a physical data section 514, a status section 516, and an action section 518. The image section 512 can include images of portions of the items that have been inducted into the item management process at the remote facility. The physical data section 514 can include physical data about the item, including size, weight, the type of mail (e.g., first class or bulk postage), the name of the entity sending the mail, the estimated number of pages (e.g., based on size and weight), and/or other information. The status section 514 can include the date the item was received and whether the item has undergone any processing.

In FIG. 5, the action section 518 can include a menu or entry field where the remote user can provide instructions regarding the processing of the individual items. For example, in the illustrated embodiment the user can choose to shred a mail item, scan a mail item, or send a mail item. For example, if the user chooses to shred the mail item, the item will be shredded and recycled. In some embodiments, the item management process can include selling the recycled material. If the user chooses to scan a mail item, an additional screen can allow the user to choose to scan the entire item or a certain number of pages. Once the item is scanned the user can view the scanned images and if necessary provide additional instructions. If the user chooses to send a mail item, an additional screen can allow the user to send the item to the user or another entity. In FIG. 5, the user can also select the “remove from mailing list” option. This option can provide feedback to the item management process that indicates the user wishes to be removed from the mailing list of the entity that mailed the selected piece of mail. The management process can track this information and provide this information to various bulk mailing entities and/or to the specific entity that mailed the selected item.

The multiple links portion 511 of the display can include links to various pages including a mail transition wizard 522, a junk mail wizard 524, a mail preferences section 520, and/or other information (e.g., account information and a contact link for contacting the managers of the item management system). The mail preferences section 520 can be used, for among other things, setting up rules regarding various mail items that are inducted into the item management system and/or to allow the user to customize display formats for the user's inbox. For example, the mail preference section 520 can allow the user to indicate that mail meeting certain criteria (e.g., from certain sources and/or certain classes of mail) be deleted, shredded, recycled, held, and/or completely scanned immediately upon receipt. The transition wizard 522 can allow mail meeting certain criteria to be sent to the user or another entity immediately after induction. The junk mail wizard 524 can allow a user to designate mail meeting certain criteria to be automatically deleted, shredded, destroyed, or recycled upon receipt and in some cases direct the item management process to send a notice to the direct mail marketing entity that the user does not wish to receive any more direct marketing offers. The computer display 500 can also include other information 526, such as advertising, notices, and summary information.

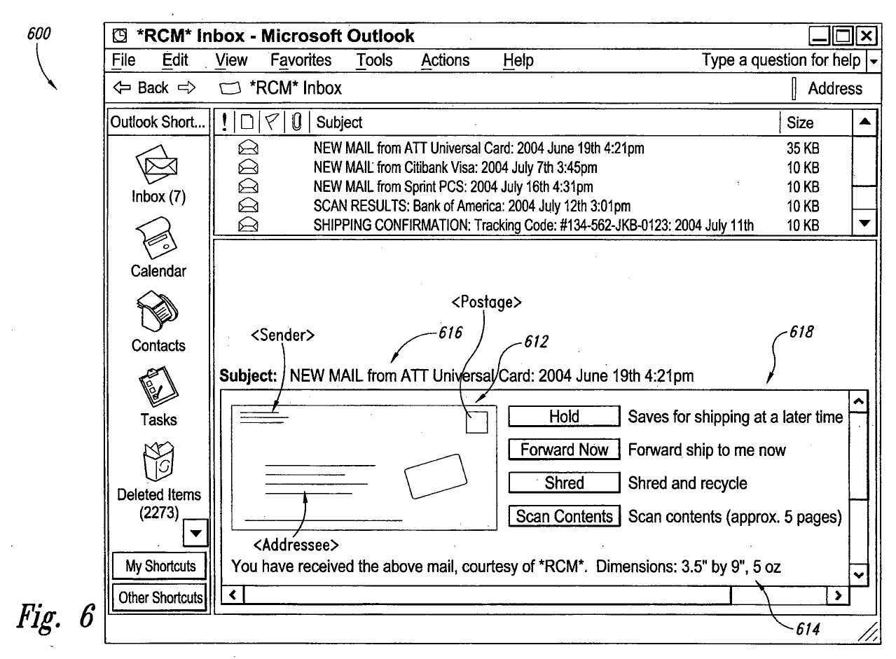

Other display pages can include other arrangements, can be arranged to perform other functions, and/or can be adapted for other types of item management systems. For example, FIG. 6 illustrates another computer display 600 through which a user can interface/interact with an item management process via personal management software, for example, through Microsoft® Outlook®, which is available from the Microsoft Corporation of Redmond, Wash. The computer display 600 in FIG. 6 includes an image section 612, a physical data section 614, a status section 616, and an action section 618.

In the illustrated embodiment, the action section 618 includes a hold function, a forward now function, a shred function, and a scan contents function. The hold function allows items to be held and shipped later. For example, it can allow the user to have an item held for a month and then shipped to a selected address (e.g., after the user returns from an extended trip). The forward now function allows the user to forward the mail item to the user immediately and the scan function allows the user to have the entire item scanned so that the entire item can be electronically reviewed. The shred function allows the user to shred and recycle the mail item. In other embodiments, the user can have the option to recycle an item without shredding. In selected embodiments, the item management process can include holding an item selected for deletion, destruction, shredding, and/or recycling for a period of time so that the user can cancel the deletion, destruction, shredding, and/or recycling of the item for a period of time (e.g., 1-3 days).

In certain embodiments, the operator interface can include display pages similar to those described above with reference to the remote user display pages so that an operator can receive information from the item management process, monitor portions of the item management process, and/or provide input to the item management process. For example, if a remote user does not have network access, the user can contact an operator via phone and provide instructions regarding the disposition of mail for a period of time. The operator can then interface with the item management system using “operator display pages” to carry out the user's instructions. Additionally, the “operator display pages” can allow the user to provide instructions to the item management process for other reasons. For example, the operator can provide instructions to the item management system to correct errors and/or to override automatic rules set up by the user. For example, if there is a natural disaster that affects the area where a user has items automatically sent, the operator can suspend the automatic sending of items to that address and notify the remote user that the automatic deliveries have been suspended. The remote user can then provide new instructions regarding the affected items.

Various embodiments of portions of the item management processes and item management systems, discussed above are discussed below in further detail. One skilled in the art, however, will understand that the present invention is not limited by these embodiments, that the present invention may have additional embodiments, and that other embodiments of the invention may be practiced without several of the specific features described below. Additionally, although for the purpose of illustration many of the embodiments below are described in the context of a remote mail system, it is understood that many or all of these embodiments are applicable to other types of items and/or item management systems.

Receiving an Item

Items can be received by the item management system via various methods. The process of receiving the item includes attaining physically possession of the item, and in some cases inspecting the item for damage and/or moving the item to a location where the induction process starts or begins. For example, in the case of a remote mail system, a user can have mail delivered to a physical building address, post office box, or a private mail box (PMB) by a commercial mail receiving agency. The mail can be picked up from the delivery location and transported to a facility remote from the user where the induction process will take place. The mail can be inspected for damage and positioned to begin the induction process. In other embodiments, the facility that includes the item management system can be a commercial mail receiving agency and have PMBs assigned to various users and the mail items can be delivered directly to the facility.

Mail items can include all types of mail, including packages and letters delivered by the US Postal Service, UPS, Fed Ex, and other letter/package delivery services. For example, a class and type can be associated with a mail item. A mail class is a category of mail defined by the mail's delivery service and content. For example, express mail, priority mail, first-class mail, parcel post, bound printed matter, media mail, standard mail and periodicals are the mail classes recognized by the U.S. Postal Service. Additionally, as discussed above, there are various commercial package, parcel, and/or letter delivery services, including courier services, which also can have discrete categories of mail (e.g., UPS land or UPS air). A mail type is a category of mail defined by the mail's dimensions. For example, postcard, letter, envelope, flat and parcel are the mail types recognized by the U.S. Postal Service.

Item Induction

Induction is the process of gathering data from or about individual items and/or sorting the items based on the gathered data. In certain embodiments discussed below in greater detail, the item management system includes a remote mail system and induction includes the process of gathering data about individual mail items and/or sorting the mail pieces based on the gathered data. There are several methods which can be used or combined to accomplish the induction process.

For example, the induction process can be accomplished manually where a person gathers data from the mail items and sorts them into containers, cartridges, or totes. For example, a person can read the outside of the envelope or parcel and sort the mail items into different containers. Manual induction requires no pre-sorting of received mail pieces into particular mail classes or mail types and manual induction successfully inducts all but the most badly damaged mail pieces. Additionally, manual induction does not require another induction method to handle exceptions. In selected embodiments where the mail item is going to be stored in an automated system, an identifying feature or identification tag, discussed above, can be applied to the mail item.

In other embodiments, an automated induction process can be used to gather data from a mail piece and sort it into a container, cartridge, or tote. An automated induction process can have various arrangements. For example, in certain embodiments a one-pass induction process can be used. In other embodiments a two-pass induction process can be used.

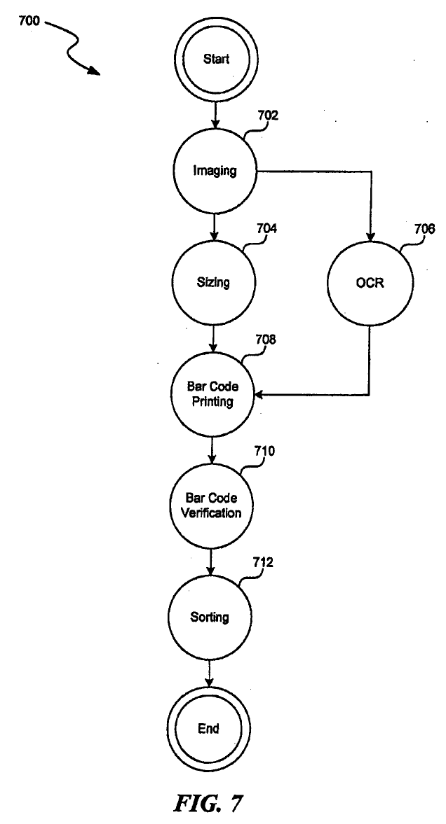

The one-pass induction process gathers data on a mail piece and sorts it in “one touch”. Once the person or machine has handled the mail piece, it need not be handled again to complete the induction process. FIG. 7 is a schematic flow chart showing a one-touch induction process 700 in accordance with certain embodiments of the invention. In the illustrated embodiment, the one-touch induction process 700 includes imaging 702, sizing 704, optical character recognition (OCR) 706, bar code printing 708, bar code verification 710, and sorting 712. The imaging process 702 includes capturing an electronic (e.g., digital) image of a mail item. In selected embodiments where an OCR process is going to be used as part of the induction process, it can be desirable to use a resolution of 240 dots per inch (DPI) or greater. The sizing process 704 can include measuring selected physical dimensions and/or characteristics of a mail piece. For example, for postcards and letters, sizing can include determining a length, height, and weight for the mail item. For flats and parcels, sizing can include determining a length, height, thickness, and weight of the mail item.

The OCR process 706 can be used to locate a portion of a mail item image that contains data relevant to the sorting process 712 and translates at least part of that portion of the image into text. The bar code printing process 708 places machine readable data onto the mail items. The bar code may or may not contain content extracted during OCR. In other embodiments, as discussed above, other identifiers, such as one or two dimensional symbols, radio frequency identification tags, identification tags, or other machine readable indicators can be used. The bar code verification process 710 reads the newly-printed machine-readable bar code (or other identification tag) on the mail item to confirm that bar code printing (or identification tagging) was successful. The sorting process 712 can divide the mail items into groups based on relevant data gathered from each mail item and/or prepare the mail items for storage. For example, in certain embodiments each piece of mail can be placed in an individual container for storage. In other embodiments, the mail can be grouped in larger containers and separated during the storage process. In still other embodiments, the induction process electronically sorts the mail items by their identification tags, but the mail items are not physically sorted until they enter the storage process.

In certain embodiments, the item management system can use commercially available machinery to perform various portions of the induction process. For example, in selected embodiments one of the Olympus Series Mail Sorting Machines, available from Pitney Bowes of Danbury, Conn., can be used to perform at least a portion of the imaging and sorting process discussed above. Additionally, in selected embodiments manual induction is still required to handle certain mail items. For example, a mail item that is too large to be inducted by machine can be inducted manually. Additionally, in certain embodiments the mail items may be manually inspected for damage and/or manually oriented before entering the automated portion of the induction process so that the induction equipment can gather relevant data from the mail items.

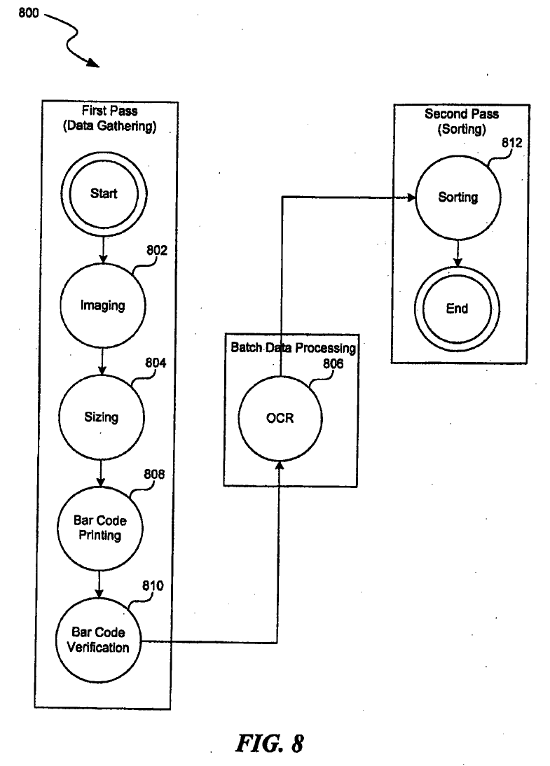

FIG. 8 is a schematic flow chart showing a two-touch induction process 800 in accordance with other embodiments of the invention. For example, in certain embodiments the “first pass” of a two-pass induction process gathers data from the mail item by performing an imaging process 802 and a sizing process 804, similar to the imaging and sizing processes discussed above with reference to FIG. 7. Additionally, a bar code printing process 808 includes printing and applying a bar code to the mail item so that the mail item has a unique identification. The bar code verification process 810 includes reading the bar code to verify that the bar code is readable and correct.

In the illustrated embodiment, a batch data process 806 includes an OCR process and/or other computational techniques to compute data associated with the mail item based on the imaging process 802 and the sizing process 804. The data is also associated with the unique identification or bar code. For example, in various embodiments the data can include:
The user or recipient of the mail item (e.g., via the delivery address determined via the OCR process);
The sender of the mail item;
The mail class of the piece (e.g., determined via the OCR process and an image of the postage area); and/or
An estimated page count of envelopes and flats (e.g., based on size and weight).

In the illustrated embodiment, the mail item passes quickly through the imaging 802, sizing 804, bar code printing 808, and bar code verification 810 processes providing. The mail item can then be held in a cache (if necessary) while the batch data process 806 is performed. Accordingly, the batch data process 806 can use as much time as required to extract and compute the sort data for each mail item. After the batch data process 806 is complete, the mail item can undergo the sorting process 812, similar to the sorting process discussed above with reference to FIG. 7. In certain embodiments, the two-pass induction process 800 can provide data that is more complete and accurate than that attained with the one-pass induction process, while maintaining a fairly high rate of throughput.

In other embodiments, the induction process can include multiple imagers and/or OCR algorithms, and mail items can be re-scanned and/or images can be re-evaluated when portions of the item are hard to identify. In other embodiments, the system may include hardware and/or software for processing the images such that the format or specific patterns of the image may be recognized for other uses. Such uses may include but are not limited to address blocks, iconography, graphics, text, and/or numeric/characters entered in blocks associated with various forms. In still other embodiments, the processing of an image for character recognition is further enhanced for speed and accuracy by using database information regarding the range of expected content can be accessed and used for comparison and/or verification purposes to determine the image content. For example, if certain mail items are received that have a specific marking that indicates the mail item is being sent to a person in a specific organization, identifying the user or recipient can be determined by searching a company specific database versus a database that contains all system users. In yet other embodiments the item management system includes multiple induction processes for different types/size mail items. Additionally, the system can include a method (automated and/or manual) for separating the different types/size mail items and sending them through the corresponding induction process. In selected embodiments at least a portion of the storage and retrieval process can be computer controlled.

Item Storage

Item storage is the process of storing items in a trackable manner so that they can be accurately and quickly identified, located, and/or retrieved at a later time. In certain embodiments, the storage process can include storing a non-uniform item in a uniform structure. For example, various embodiments are discussed below where the item management system includes a remote mail system and the storage process includes storing items so that they can be identified, located, and/or retrieved at a later time. There are several methods which can be used or combined to accomplish item storage.

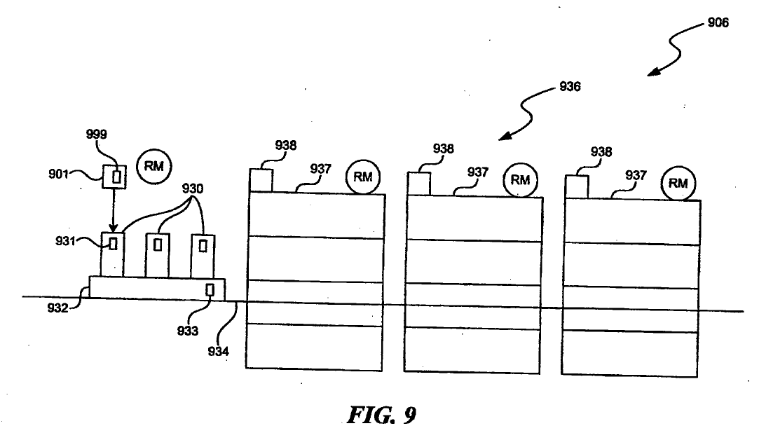

FIG. 9 is a partially schematic illustration of a storage center 906 in accordance with certain embodiments of the invention. In FIG. 9, after mail items have been inducted, each mail item 901 can be individually inserted into a container 930 (e.g., a rigid container) or cassette of sufficient size to contain the entire item 901 (e.g., the packaging and contents). In other words, each container 930 holds only one mail item 901. In certain embodiments, the mail item 901 can be placed into its designated container 930 via an automated process or handling equipment (e.g., via a robotic manipulator RM). In other embodiments, the mail items 901 can be placed into their respective containers 930 or cassettes during the induction process and then enter the storage process. Additional sorting can also be accomplished during the storage process. In selected embodiments, the containers 930 can be an injection molded sleeve with 5 sides and one open side or face for the insertion and removal of mail items 901. In certain embodiments, the container 930 can have an anti-static configuration. In various embodiments, the container 930 can also have internal ribs oriented toward the open face to prevent the portions of the mail item 901 from clinging to the inner surfaces of the container 930.

The containers 930 can each have a unique identifier 931 so that each container can be uniquely identified by visual and/or electronic means. For example, in certain embodiments the containers 930 can each carry an identification tag (e.g., barcodes or radio frequency identification tags) so the mail item in the container can be associated with that container. The containers 930 can also include physical features (e.g., engagement mechanisms) which allow them to be inserted into and retrieved from a storage rack system 936 (which includes one or more racks 937), be transported on a conveyor system 934, be carried by a carrier 932 (discussed below in further detail) and/or be manipulated by a robotic manipulator RM. Such features may include but are not limited to slots, pins, grooves, hooks, or other engagement devices for engaging portions of the rack system 936, conveyor system 934, and/or robotic manipulator RM.

In the illustrated embodiment, one or more of the containers 930 can be carried by a carrier 932 or pallet. In selected embodiments, the containers 930 can be uniform in shape and size so any container can be positioned in any location or slot on a carrier 932. In certain embodiments, the carriers 932 can allow multiple containers 930 to move through the storage center and/or be stored in the storage center together. The carrier 932 to also carry an identifier 933 so that movement of the carrier can be tracked throughout the storage center. In certain embodiments, the carriers 932 can include features to permit stacking or nesting them for storage (e.g., in the rack system 936). The carriers 932 can also include features that allow the container 932 to be inserted into and retrieved from a storage rack system 936, be transported on a conveyor system 934, and/or be manipulated by a robotic manipulator RM.

The carriers 930 can be dispatched along a conveyor system 934 to the storage rack system 936. The conveyor system 934 may include transfer locations to re-direct the carriers 932 to other sections of the storage center and/or out of the storage center (e.g., to the processing center). In certain embodiments, decisions regarding the direction or diversion of the carriers 932 can be partially or completely automated. Additionally, in selected embodiments at least a portion of the storage and retrieval process can be computer controlled. In various embodiments, the conveyor system can include return lines to allow carriers 932 that have been moved out of the storage center (e.g., moved to processing) to be directed back to the induction center and/or allow containers with mail items to return to the rack system 936. This can permit items to be retrieved in one portion of the rack system 936 and directed to a different portion of the rack system 936 or moved out of the storage center and returned.

In the illustrated embodiment, a carrier 932 with one or more containers 930 is transported via the conveyor system 934 to an individual rack 937 in the rack system 936, where the carrier 932 (with the containers 930) is removed from the conveyor system 934 and placed into the individual rack 937. The item 901 can carry a unique identifier 999. Accordingly, if the item identifier 999 was associated with the container identifier 931 and the container identifier 931 was associated with the carrier identifier 933, the item identifier 999 can now be associated with the individual rack in which the carrier 932 is stored. For example, the individual rack 937 can include a rack identifier 938, each location in the rack can include an identifier, and/or the system can identify the rack by the position in the conveyor system 934 where the carrier 932 was removed and placed in a rack. In one embodiment, all of the identifiers include bar codes and the bar codes are scanned at each step of the process. In other embodiments, the identifiers include radio frequency identification tags which are sensed at each step of the process.

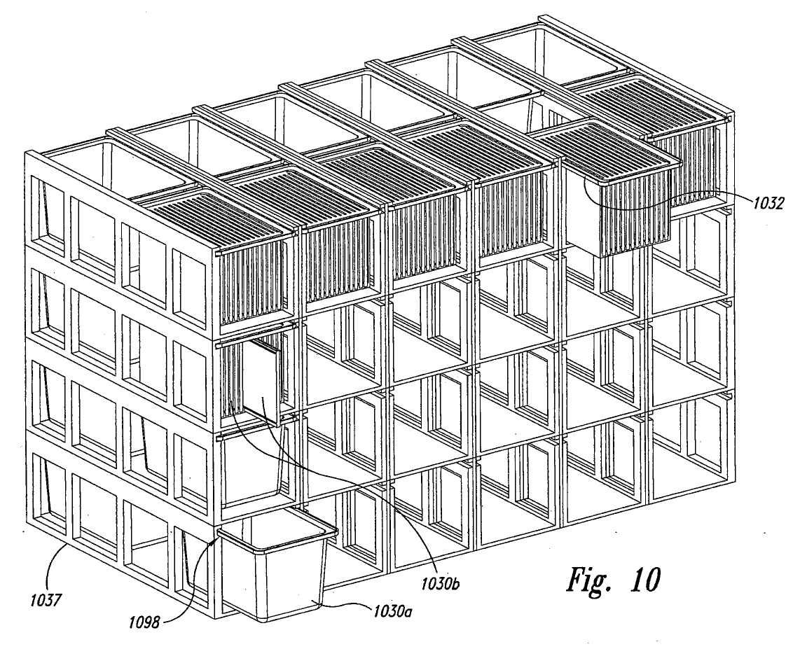

FIG. 10 is an isometric illustration of an individual storage rack 1037 configured to store multiple different types of containers in accordance with various embodiments of the invention. For example, the rack 1037 shown in FIG. 10 is configured to store a first container 1030a without a carrier. In certain embodiments, the first carrier 1030a is moved throughout the storage center without the use of a carrier. In other embodiments, the first carriers 1030a are moved throughout a least a portion of the storage center on a carrier and removed from the carrier when they are placed into the rack 1037. As discussed above, the rack 1037 and first container 1030a include engagement mechanisms 1098 to aid in interfacing and/or securing the first container 1030a to the rack 1037. As discussed above, similar engagement mechanisms can be used on other containers, other racks, robotic manipulators, portions of the conveyor system, and/or other storage center components. In the illustrated embodiment, the rack 1037 also carries second containers 1030b. The second containers 1030b are carried by carriers 1032, which in turn are carried by the rack 1037. In the illustrated embodiment, the individual second containers 1030b can be removed individually from the carriers 1032, even while the carrier is in the rack 1037. Additionally, the carriers, with any associated second containers, can be removed from the rack 1037 as a unit.

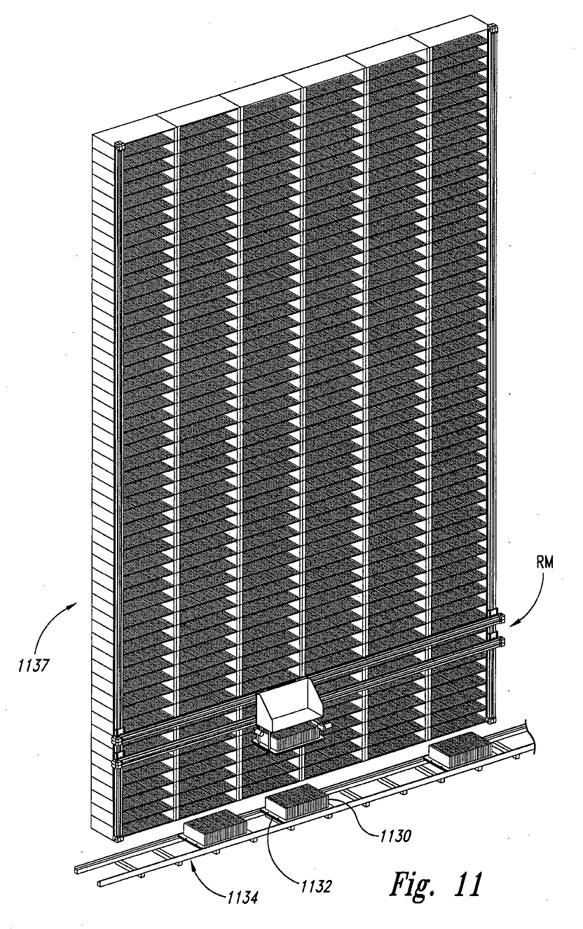

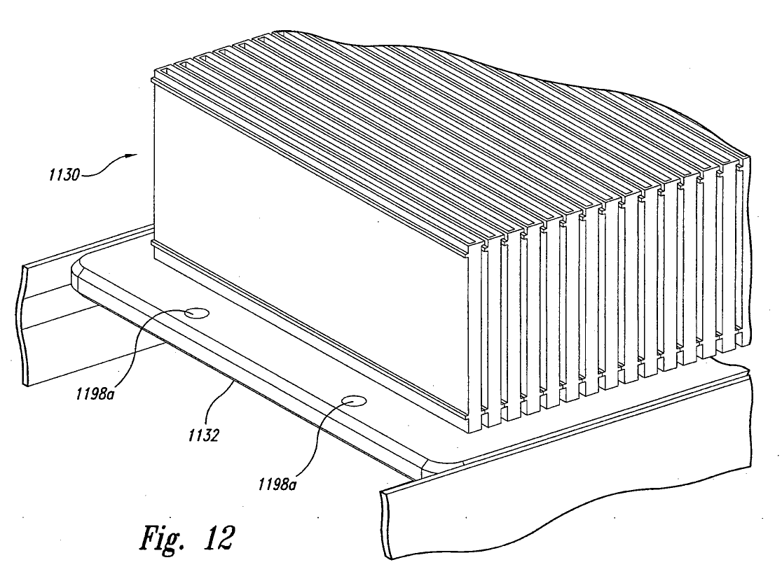

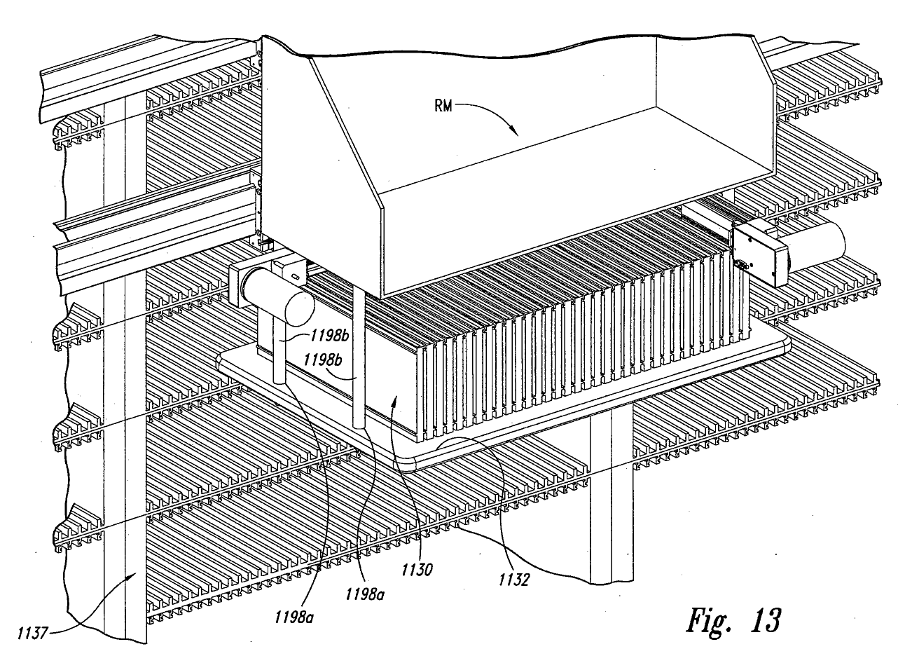

FIGS. 11-13 are isometric illustrations of a rack 1137 with a robotic manipulator RM that is used to insert containers 1130 into the rack 1137, remove containers 1130 from the rack, and manipulate containers 1130 relative to the rack 1137 in accordance with other embodiments of the invention. FIG. 11 shows the rack 1137, the robotic manipulator RM carrying a carrier 1132 with containers 1130, and a portion of a conveyor system 1134 carrying additional carriers 1132 and containers 1130. FIG. 12 shows a portion of a carrier 1132 carrying containers 1130. Two first engagement devices 1198a (e.g., female engaging devices) are shown in FIG. 12, however, other embodiments can have more, fewer, or no first engagement devices 1198a. FIG. 13 shows the robotic manipulator RM carrying a carrier 1132 with multiple containers 1130. In FIG. 13, the second engaging devices 1198b (e.g., male engaging devices) have engaged first engaging devices 1198a on the carrier 1132. The robotic manipulator RM is configured so that it can move at least vertically and horizontally with respect to the rack 1137 and the conveyor 1134 (shown in FIG. 11). Additionally, the robotic manipulator 1137 is configured so that it can move individual containers 1130 in and out of the rack 1137. In the illustrated embodiment, the rack 1137 includes multiple engaging devices for engaging the individual containers 1130 as they are slid into and removed from the rack 1137. Once one or more containers 1130 are removed from the carrier 1132 and placed in the rack 1137 or removed from the rack 1137 and placed on the carrier 1132, the carrier 1132 can be returned to the conveyor system 1134 (shown in FIG. 11) and moved throughout or out of the storage center.

In other embodiments, the storage center can have other arrangements. For example, in certain embodiments multiple mail items are placed in a single container based on user and/or operator defined rules. For example, multiple magazine type mail items for a specific user are placed in a single container. In still other embodiments, the containers can be integral with the carriers. In yet other embodiments, the mail items are placed in containers, moved throughout the storage center, and transferred to other containers for placement into a rack.

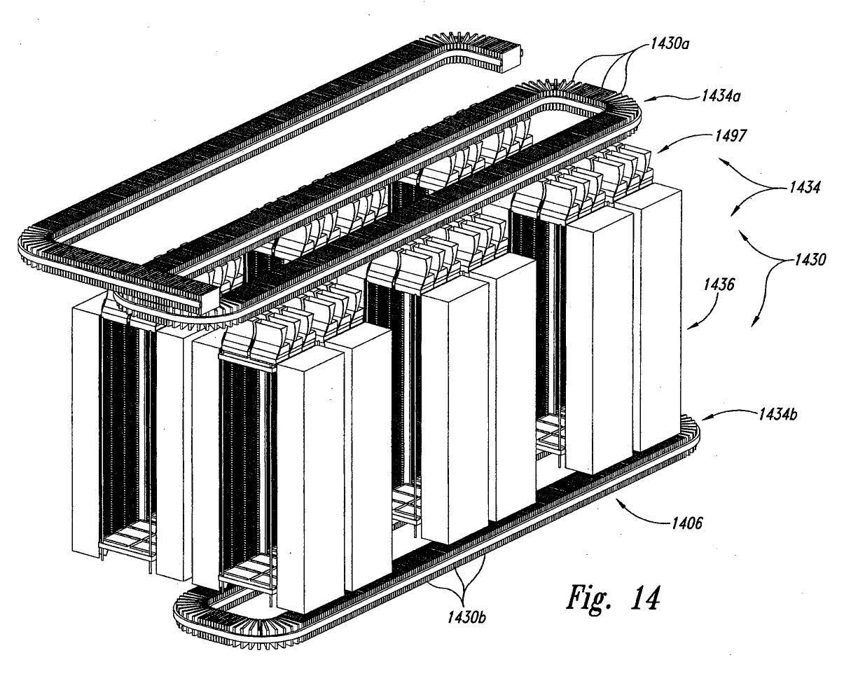

For example, FIG. 14 is an isometric illustration of a portion of a storage center 1406 with containers 1430 permanently attached to one or more conveyor systems 1434 in accordance with certain embodiments of the invention. In the illustrated embodiment, the storage center 1406 includes a first conveyor 1434a that has first containers 1430 permanently attached to the first conveyor 1434a. In the illustrated embodiment, each first container 1430a has an open top, four sides, and a sliding or moving bottom which can be opened, actuated, or retracted to allow the material to drop out the bottom when desired. Mail items are placed in the containers during the induction process or the storage process.

In FIG. 14, when a mail item is above the rack destined for storing it, the bottom of the container opens and the mail item drops into either a cache or directly onto a robotic manipulator. In the illustrated embodiment, the mail item drops through a chute system 1497, which guides the mail item between the first container 1430a and the specified rack. In other embodiments, the storage center 1406 does not include a chute system 1497. If the mail item falls into a cache, it is held in the cache until the robotic manipulator is available to handle the mail item. The robotic manipulator can move relative to the corresponding rack and move the mail item into and out of storage locations in the corresponding rack. In the embodiment shown the manipulator is configured to move vertically.

Each manipulator contains one or more devices to translate the mail piece into the rack storage slot or space that the manipulator is adjacent to. The device used to move the mail piece from the manipulator into the slot, and similarly from the slot onto the manipulator is conceived to be one of two forms. One such form is a belt device on which the mail piece is deposited from the chute 1497 or cache. When the piece is on the belt, and the manipulator has moved vertically to a rack slot that is not occupied, the drive mechanism of the belt may be energized such that the mail piece on the belt is transported along the belt into the slot location. When the belt velocity is sufficient, the piece may continue with momentum to completely leave the belt and come to rest completely within the rack slot.

Another embodiment is configured to move the mail piece from the manipulator into the rack storage slot is a pusher or set of fingers so arranged as to push the piece from one location to another. An arrangement of a pusher may be constructed so as to translate from the manipulator surface to the storage slot. When a mail piece is on the manipulator surface, the pusher may be engaged or powered by any form of motive device (pneumatic, hydraulic, or electric motor, solenoid, piston, or similar conversion from energy to motion). When the manipulator is positioned adjacent or aligned to the storage rack slot, the pusher system is energized to move slidingly across the top surface of the manipulator thereby translating any piece or pieces resting on the surface in the direction and by the distance the pusher moves. When the pusher translates the piece the full distance required to reach the storage slot, the piece being pushed is fully deposited into the storage slot.

To remove material from the rack, the robotic manipulator removes the mail item from its storage slot and places or drops the mail item to a location where the mail item can be dropped or placed in a second container 1430b on the second conveyor 1434b and moved away from the storage rack. To remove the piece from the storage slot, the aforementioned pusher can be positioned behind the mail piece in the slot and moved in the reverse manner with respect to the storage method so as to pull the mail piece from the storage slot onto the adjacent manipulator platform. Movement of the mail piece from the manipulator into the storage slot whereby the piece drops or moves to the second conveyor is effected in the same manner as described for moving the piece into a storage slot.

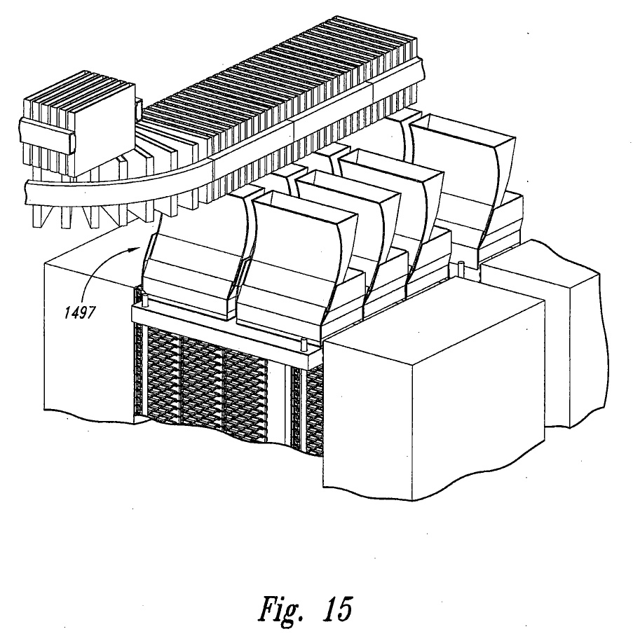

FIG. 15 is an isometric illustration of a chute system used to transfer items between first conveyor 1434a and the rack system 1436 shown in FIG. 14. In other embodiments, the storage center can include additional conveyors, each having permanently attached containers for moving mail items throughout the storage center. In some circumstances it can be necessary to transfer mail items between conveyor systems. In some of these embodiments, a chute system, similar to that shown in FIG. 15 can be used to aid the gravity transfer of mail items between one conveyor and another. In other embodiments, the transfers can be made without a chute system and/or with the aid of a robotic manipulator.

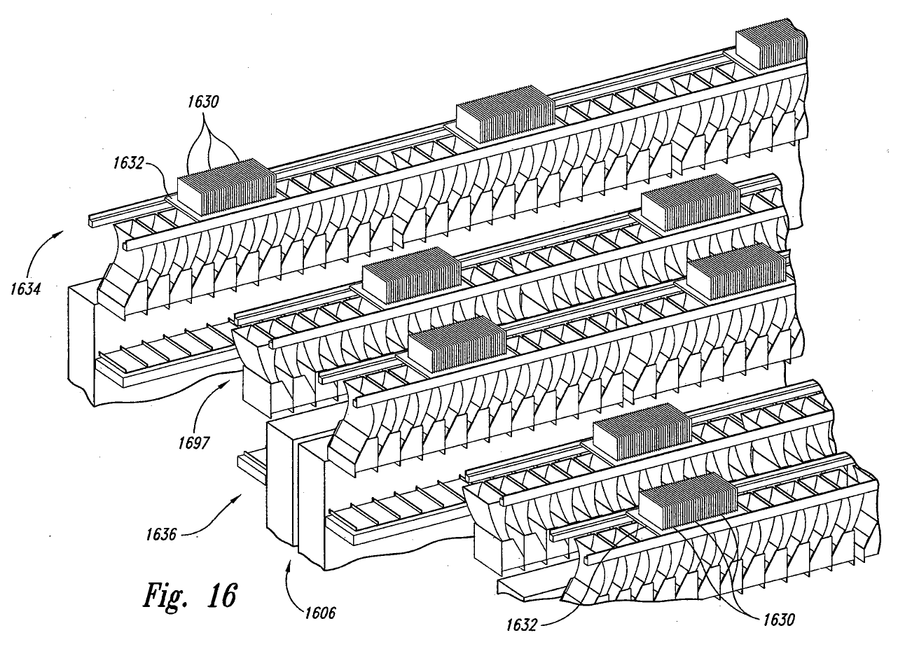

FIG. 16 is an isometric illustration of a portion of a storage center 1606 with a chute system 1697 for transferring containers 1630 between one portion of the storage center 1606 and another. For example, in FIG. 16 containers 1630 can be carried by carriers 1632 on a conveyor 1634. When a container 1630 is over a rack in the rack system 1636 designated to store the container 1630, the carrier 1632 can release the container 1630, allowing it to drop into a cache or onto a robotic manipulator. The container 1630 can then be stored in a manner similar to that for storing the mail item discussed with reference to FIG. 14. The chute system 1967 can aid in guiding the container into the rack. The container can be removed from the rack in a manner similar to that of removing the mail item discussed with reference to FIG. 14. In other embodiments, the storage center 1606 does not include a chute system 1697.

In certain embodiments, once materials are deposited in the rack system, a robotic manipulator may be used to sort, reorder, or otherwise organize the positions of a rack's contents for purposes of a sequenced retrieval order, grouping of items based on attributes, or to minimize the robotic traversal times for future retrievals. For example, during periods when a robotic manipulator of a given rack is not engaged in placing items from a conveyor system into storage or retrieving items and placing them on the conveyor system, the robotic manipulator can be directed to retrieve and re-insert containers to better organize the contents of the rack. This may be accomplished by moving groups of containers (e.g., a group of containers stored on a carrier) or by moving individual carriers. In certain embodiments, the storage system can reorganize containers by moving containers between racks, for example, by using a portion of a conveyor system.

In one embodiment, mail items are re-ordered in the rack so that the mail items are retrieved from the rack system in the order or in the reverse order of a carrier delivery route. This can involve a computer system determining the carrier route order and selecting all the corresponding mail items in the storage center that match the chosen sequence. The mail may be retrieved in order regardless of whether it is distributed throughout the storage center or entirely contained within a single rack. The same logic can be used for initial placement of mail items in the storage center. For example, in some embodiments items can move from induction to specific racks associated with certain sequences or rules and/or be stored within certain portions of a rack based on these selected sequences or rules. In other embodiments, items can be stored on racks that are proximate to one another to enhance retrieval sequencing.

Item Retrieval

As discussed above, items can be retrieved by the storage center and sent to the processing center for processing. In certain embodiments, the storage center can retrieve items in a specific sequence or order regardless of where they are stored in the storage center (e.g., stored in the rack system). For example, in selected embodiments this can be done by transporting a carrier to various locations throughout a rack system to collect various mail items and/or containers in a specific sequence or grouping. In other embodiments, multiple carriers can be directed through the system to collect items for segments of a sequence, and when all items are collected, the carriers can exit the system in the order necessary for further processing. In still other embodiments, multiple carriers can be directed through the system to collect items for a selected grouping and once all the items are collected, the carriers can exit the system to carry the items to the processing center.

Item Processing

Items retrieved from the storage center can be processed in a variety of ways depending on the type of items being stored, the action(s) desired by a user, and/or the action(s) desired by an operator. For example, processing can include, but is not limited to, removing items from the item management process, shipping items (e.g., to a user or other entity), performing various manual operations on items, altering the items, scanning or imaging the items, marking the items, separating the items, disposing of the items, recycling the items, destroying the items, and/or simply passing the items through the processing center and returning the items to the storage center (e.g., when an item has been removed with a group of other items from storage and/or an item has been removed from storage by mistake). In other embodiments, items that are being archived can be retrieved, moved through the processing center, and returned to the storage center for storage in a different area. In other embodiments, items can be archived (e.g., moved to another location in the storage center) without leaving the storage center.

In one embodiment, the item management system includes a remote mail system and items can be removed from storage so that at least a portion of the item can be scanned (e.g., the entire mail item including the packaging and contents). For example, as discussed above, a user can remotely review details about an item that has been inducted and stored, and provide instructions to have the document scanned. In response to the user's input, the document can be retrieved from storage and moved to the processing center for scanning. The scanning process can be fully automated, partially automated, or accomplished manually.

Once the mail item is received at the processing center, the scanning process can include scanning at least a portion of the packaging 1702 (e.g., the outside of the mail item) and making duplicate packaging, materials 1704. For example, in certain embodiments a portion of an envelope that includes a bar code applied during the induction process can be scanned. A duplicate envelope can be printed with the same images and bar code. In other embodiments, the corresponding bar code can be electronically added to an image taken during the induction process and the composite image can be printed on the duplicate envelope. In other embodiments where other types of identification tags are used, a duplicate identification tag can be applied to the duplicate packaging materials.

The packaging can be opened (process portion 1706), either manually or using an automated extraction machine. For example, in certain embodiments an automated extraction machine can slit an envelope and remove the contents. In selected embodiments, the packaging can be scanned (process portion 1702) and the duplicate packaging material (process portion 1704) can be accomplished after the packaging has been opened or after the contents have been removed.

Once the packaging is opened and the contents removed, other portions of the mail item can be prepared for scanning (process portion 1708). For example, in certain embodiments, if the contents include multiple pages that are stapled and folded, the papers can be unfolded and the staples can be removed. The papers can then be placed between the original and duplicate packaging materials so that the scanner will be able to determine the start of the mail item and the end of the mail item. For example, the scanner or related computing device can determine that the entire mail item has been scanned when a repeat image or identification tag is sensed. The mail item can then be scanned in its entirety (process portion 1710). After scanning, the mail item (e.g., the contents and original packaging) can be placed in the duplicate packaging material (process portion 1712) and be returned to storage or undergo further processing. The scanned image of the entire mail item can then be sent to the user electronically for review. In certain embodiments, the scanned image can be manipulated (e.g., indexed and/or enhanced) before being sent to the user.

Document Storage, Item Storage, and Other Features

Although various embodiments of an item management system or process have been described above in the context of a remote mail system, in other embodiments the item management system or process can have other features and/or applications.

For example, in certain embodiments the item management system can include a document management system. For example, the item management system can receive an item (e.g., from a user via mail or delivery) that includes a pouch or other container (e.g., packaging) with one or more documents inside (e.g., content). In selected embodiments, the item can include bar code or other identifier when the item is received (e.g., the pouch can already have an identifier when the user places the documents in the pouch) and the item can be inducted into the system using this identifier and stored. Additionally, in certain embodiments the user can provide a description of the pouch content and/or other information about the pouch via the user interface so that this information can be stored and associated with the identifier when or after the item is inducted. This information can also be stored in a searchable database or system that allows the user to use the system to find items stored via the bar code with the associated information.

The item can be stored per a set of rules pre-established by the user and/or the operator. In certain embodiments, the container portion of the item can be sealed and the item can remained sealed until it is retrieved and returned to the user, protecting the privacy of the container's contents. Additionally, the seal can provide an indication of whether the privacy and/or security of the item have been breached. A monitoring system, similar to those discussed above, can provide additional security.

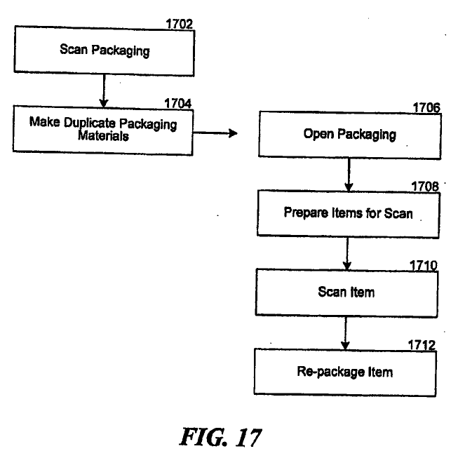

In other embodiments, the item can be processed before storage. For example, after induction the item can be moved to a processing center where the item can be opened, the contents scanned, and the item resealed (e.g., in a duplicate envelope as discussed above with reference to FIG. 17). The item can then be stored and the scanned images can be stored electronically to provide a record of what is being stored, to provide backup copies of the stored item, and/or to make the electronic images available for remote viewing.

In further embodiments, the item can be retrieved from storage and sent to a user via the processing center. The user can modify the item, for example, add and remove papers from a pouch, and return the item to the item management system. During the induction process, the item management system can identify the item as a returned item (e.g., based on an identification tag) and send the item to processing based on a pre-determined set of instructions. At processing the item can be opened and the contents can be scanned. The item can then be sent to storage. The new images can be compared to the stored record to determine changes made to the item and/or to create a new record of what is being stored. Accordingly, a user can have a current inventory of the item stored and/or a history of changes made to the item. Additionally, in other embodiments the processing center can provide other types of processing, for example, other types of processing can include recycling, shredding, copying, and shipping the item or a copy of the item to another entity. In still other embodiments, an item management system can include both a remote mail system and a document management system.

The embodiments of the item management system discussed above can also be used for other types if items. For example, in certain embodiments an item management system can be used to store items that include CD/DVD. The CD/DVD can be configured for any type of data storage, including audio and/or visual data. The system can be used to track the location of the CD/DVD, how often they have been used, how they have been used, and/or how they have been modified. Accordingly, this feature can be particularly useful for an in-store or by-mail CD/DVD rental facility. In other embodiments, the items can include books that are lent to various entities (e.g., by a library), provide many of the same features and advantages discussed with reference to CD/DVDs.

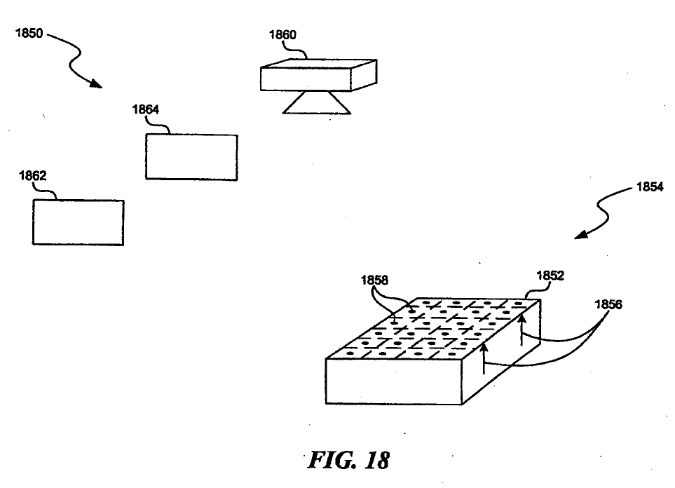

Additionally, it will be understood by those skilled in the art that various embodiments of item management systems can be used on a small scale (e.g., in an individual company's mail room) or on a large scale (e.g., a remote mail and document management system serving multiple companies around the world). For example, FIG. 18 illustrates a manual induction station 1850 that might be used in a corporate mail room in accordance with certain embodiments of the invention. A similar process can be used in conjunction with an automated induction system (e.g., for use with a large scale remote mail system) to induct items that are incompatible with the automated induction process (e.g., to induct items that are too large for the automated system).

In the illustrated embodiment, the manual induction station 1850 includes a table or platform 1852. Various sensors can be coupled to the platform. For example, in FIG. 18 weight sensors 1856 are positioned so that a weight of an item placed (e.g., manually placed) on the platform 1852 can be sensed. Additionally, in the illustrated embodiments electromagnetic sensors 1858 (e.g., photo diodes) are positioned on or in the platform 1852 to sense the size (e.g., a two dimensional size) and/or shape of an item based on the number of electromagnetic sensors 1858 that are covered when the item is placed on the platform 1852.

Additionally, in the illustrated embodiment the manual induction station can include one or more imaging devices 1860 (e.g., a scanner and/or camera). The imaging devices 1860 can be handheld or mounted proximate to the platform 1852. The imaging device 1860 can be used to capture an image of all or a portion of an item, and in some cases can gather other information about the item. For example, in selected embodiments the platform 1852 can have dimensional markings 1854 on or in a surface of the platform 1852, and the imaging device 1860 can provide dimensional data by imaging the item relative to the dimensional markings 1854. The image device can be configured to compute various dimensions (e.g., width and length) of the item based on the image or send the image to a computer system, which in turn can compute the dimensions. In some embodiments, an index marking (e.g., a corner of the platform 1852) can be used to aid an operator in orienting the item on the platform 1852 to facilitate gathering dimensional data. In other embodiments, the platform 1852 can be transparent and the imaging device 1860 can be placed below or be integral with the platform 1852.

In still other embodiments, the manual induction system 1850 can have other arrangements. For example, in certain embodiments a data entry device 1862 can allow the operator to manually enter data regarding the item. For example, in selected embodiments the operator gathers dimensional data visually using the dimensional markings 1854 and enters the data into the data entry device 1862. In other embodiments, the operator uses the data entry device 1862 to enter any damage on the item that the operator observes. In still other embodiments, the manual induction station can include other device(s) 1864. For example, in one embodiment the other device(s) 1864 can include a device that provides an identifier for the item (e.g., a printer that prints a bar code sticker which the operator places on the item). In another embodiment, the other device(s) 1864 can include a device that reads identifiers, such as a bar code reader or radio frequency identification reader. In still other embodiments, the other device(s) 1864 can include a device that provides the operator with sorting instructions, for example, a computer monitor that provides instructions to the operator to place the item in a container and send it to storage or to send the item to processing based on a pre-determined set of rules as discussed above.

As discussed above, in selected embodiments an item management system can be used on a small scale (e.g., in company mail room) or on a large scale (e.g., on an international basis). For example, in certain embodiments an item management system can include a system for sorting mail items at a postal facility. As used herein, a postal facility can include a National Postal Service, such as the United States Postal Service or other type of governmental or privately owned Universal Service Provider (“USP”), such as FedEx, UPS, etc. Selected embodiments of item management systems discussed above can be used in these facilities to provide greater efficiency, and in some cases, to provide additional services to the customers.

Current postal facilities utilize sorters that have a limited number of bins (e.g., typically 100 to 200 bins per sorter). This results in each mail item or piece of mail having to be sorted 10-12 times before finally being delivered to the end-customer. In some cases, the final sortation is accomplished by a mail carrier who delivers the mail to various locations.

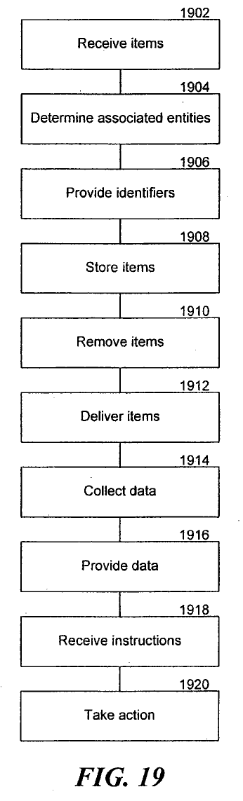

In selected embodiments, item management systems having features similar to those discussed above can be used to sort mail items at a postal facility. For example, as shown in FIG. 19, the systems can be configured to receive multiple mail items at the postal facility (process portion 1902), for example, mail items that have been collected from mail boxes, dropped of at mailing/shipping sites, and/or otherwise collected (e.g., via carrier pickup). Each mail item can be associated with at least one remote entity via a mailing or shipping address.

The system can be configured to determine which of the remote entities are associated with each mail item (process portion 1904) and provide a unique identifier with each mail item (process portion 1906). For example, in one embodiment an automated induction process can be used to, among other functions, image the mail items, dimension or measure the mail items, weigh the mail items, and/or apply an identifier (e.g., a barcode or RFID) to the mail item. The system can then store the mail items in discrete storage locations associated with the provided identifiers so that the mail items are retrievable for delivery to the associated remote entities (process portion 1908).

For example, each mail item can be placed in a storage location (e.g., a bin or cassette) that corresponds to the identifier placed with the mail item. In selected embodiments, the identifier can correspond to a mailing address or an individual so that all mail items going to a certain mailing address are stored in the same storage location. The mail items can remain in the storage location until they are ready to be removed (process portion 1910) and delivered (process portion 1912) or ready for some other action.

In certain embodiments, mail items can be removed from the storage location and delivered to the mailing address. In other embodiments, the storage location can include a bin or cassette that can be removed and transported during a delivery process. For example, in certain embodiments the bin can be carried on a delivery vehicle to a receiving address (e.g., a mailing of shipping address). The mail items can be removed and delivered and/or the bin can be delivered and the recipient (e.g., associated entity) can remove the mail items from the bin.

A feature of some embodiments of this system is that a selected mail item can be tracked from the time the selected mail item goes through the induction process until it is delivered. Additionally, in selected embodiments, the system can provide additional features similar to those discussed above with reference to other embodiments of item management systems. For example, in selected embodiments data about the mail items can be collected during or after the induction process (process portion 1914) and at least a portion of the data can be provided to at least one associated entity via a computer network (process portion 1916). Additionally, in certain cases, the associated entity can provide disposition instructions regarding selected mail items based on the data the entity receives via the computer network, the instructions can be received by the system (process portion 1918), and at least one action can be taken that is associated with carrying out the instructions (process portion 1920).

For example, in selected embodiments an associated entity can request that a mail item be shredded, discarded, recycled, opened and scanned, or re-routed to a different address. In some embodiments, this feature can allow items to be discarded prior to being delivered to the addressee, thereby potentially saving money and time for the postal facility and/or consumer. Additionally, in selected embodiments the entity can request other actions including remittance processing and/or other business functions. For example, in some case the entity can request that a check contained in a mail item be deposited in a selected bank account. In other embodiments, the system can be configured to identify mail items having a selected characteristic (e.g., a selected address, a selected return address, etc.), and automatically open the selected item, scan the contents, and/or deposit checks contained in the mail item into a selected bank accounts.

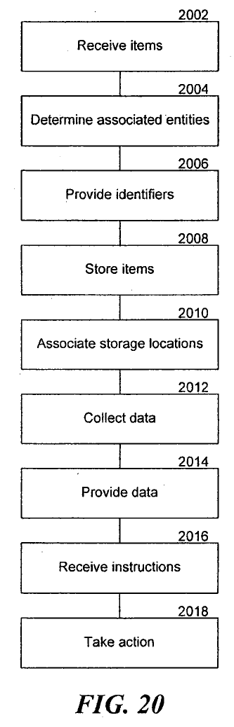

In other embodiments, an item management system can be configured to deliver items at a facility. For example, as shown in FIG. 20, in selected embodiments an item management system can be configured to receive a physical mail item (or other item) at the facility where multiple entities receive mail items (process portion 2002). For example, the facility can include a kiosk or system associated with a neighborhood, one or more office buildings, a college campus, or any other collection of entities (e.g., mail recipients, customers, etc.) The mail item delivered to the facility can be associated with at least one of the entities that receive mail items via, or at, the facility. The system can determine which of the entities are associated with the mail item (process portion 2004), provide a unique identifier with the mail item (process portion 2006), and store the mail item in a discrete storage location (process portion 2008). The system can associate the discrete storage location with the identifier of the physical mail item so that the mail item is retrievable by an associated entity (process portion 2010).

For example, in certain embodiments each entity that receives mail items via the facility can have dedicated bin(s) or cassette(s) in which mail items are stored. In some embodiments, the entity can have manual access to the bin via a locking door. In other embodiments, the system can deliver the item to the entity upon request via an automated item retrieval process similar to the retrieval process discussed above with reference to other embodiments. In still other embodiments, bins can be assigned and reassigned to store items with selected identifiers on a real time basis. For example, when the volume of items that the various entities receive varies over time (e.g., daily and/or weekly), the bins can be reassigned to accommodate the changing volumes.

In selected embodiments, data about the mail items can be collected during or after the receipt of the items (process portion 2012) and at least a portion of the data can be provided to at least one associated entity via a computer network (process portion 2014). In certain cases, the associated entity can provide disposition instructions regarding selected mail items based on the data the entity receives via the computer network, the instructions can be received by the system (process portion 2016), and at least one action can be taken that is associated with carrying out the instructions (process portion 2018). For example, in certain embodiments receiving instructions can include receiving a request to provide the physical package to an associated entity and taking at least one action can include identifying the physical package via the identifier and providing the physical package to the associated entity (e.g., via an automated retrieval process).

In certain embodiments, the item management system can include an Autonomous Mail Storage and Dispensing Kiosk where the post office and/or private carriers can deliver mail items for a particular neighborhood, office building, college campus, or other collection of customers, to a single location where it is automatically taken in and securely stored. Once mail items are loaded into the Kiosk, customers may retrieve their mail at their own convenience by walking up to an ATM-like console where they enter their address (or account number) and a password. The Kiosk automatically retrieves all the mail items belonging to that recipient and deposits them into a collection bin for the customer to remove. In selected embodiments the Kiosk can be totally autonomous, secure, available 24 hours a day, and/or internet-enabled.

In some embodiments, the Kiosk can be connected via internet or other computer communications network to a central application and also to an operations center at the post office or the common carrier. The Kiosk facility can contain an Automated Storage and Retrieval System (“AS/RS”) that holds each piece of mail in its own rigid cassette and autonomously retrieves mail items based on customer commands.

An “Inductor/Loader” machine can be used to perform the induction process when new mail items are delivered to the Kiosk (e.g., by the post office or a private carrier). The Inductor/Loader can be totally automatic such that an operator simply deposits the mail item into the machine or can include manual steps associated with the induction process (e.g., associated with imaging, dimensioning, weighing, attaching a bar-code, etc.). In certain embodiments, Optical Character Recognition (“OCR”) is used to identify the addressee of each piece, and to load the image of that piece and its dimensions and weight characteristics into an online account for that addressee to access via a computer network, such as the internet.

In selected embodiments, each addressee can log onto a computer network and view the mail that is in his or her account (e.g., via a remote computer and/or a console at the Kiosk). For example, the addressee can view the envelope image of each piece of mail that is being stored for them at the Kiosk. In certain embodiments, using the computer interface the addressee can selectively choose any mail piece or parcel to have it recycled, shredded, forwarded to another location (alone or as part of a group of mail items), opened and its contents scanned (including the automatic deposit of any checks) if the contents have not been previously scanned, printed to a remote printer, and/or delivered to the user (e.g., standing outside the kiosk).

In some embodiments, the postal or private carrier will extract all mail items from the Kiosk that have been designated to be processed by the post office/private carrier (e.g., shredded). All other mail can be left in the Kiosk to await pickup by the addressee. In certain embodiments, mail left in the Kiosk longer than the permitted period of time (e.g., 30 days) may be removed by the postal or private carrier and returned to the sender. In some embodiments, mail items returned to the post office/private carrier can be identified and/or sorted using the identifier applied by the Kiosk. In certain embodiments, this can allow the mail items to be processed quickly and efficiently.

In some embodiments, features discussed above can provide some advantages for the entities or addresses. For example, the addressee can determine whether there is important mail to pick up before bothering to make a special trip to the Kiosk. In addition, when an addressee is traveling they can still have immediate access to their mail by having it forwarded by the post office/private carrier to another location or scanned into an electronic document. In selected embodiments, the system can include billing software that bills the addressee for this service and/or provides the addressee with the ability to view an online account with the post office/private carrier.

In some embodiments, features discussed above can also provide advantages for the post office/private carrier. For example, many post offices have an insufficient number of PO Boxes in their existing branches to meet customer demand. Building compact Kiosk units in distributed locations can increase revenues from PO Box rental while lowering the “final mile” costs of delivery because a mail carrier can deliver mail items for a group of people to one central location. In selected embodiments, the online services a post office/private carrier can offer to its' customers can be provided for a fee. The item management system can include an account tracking or billing process to the consumer and provide revenue for the post office/carrier. In certain embodiments, fees can be collected for various services, including mail item delivery, mail item forwarding, document destruction, and document scanning, and/or the like.

In addition, integration with online services and the fusion of mail item delivery may keep the post office/private carrier relevant in the future as email and other electronic media continue to cannibalize what were traditionally postal mail communications. The integration with online services and the fusion of mail item delivery may keep the post office/private carrier relevant in the future as email and other electronic media continue to cannibalize what were traditionally postal mail communications. Documents scanned into electronic format by the Post Office can retain official “postmark” evidence of delivery, which is important for certain legal mailings.

In still other embodiments, Private Mail Box (“PMB”) operators, such as Mail Boxes Etc., can use an item management system (e.g., an autonomous Kiosk) to deliver mail to its group of customers. In yet other embodiments, an autonomous Kiosk used to serve a large group of related entities (e.g., employees at a large company) can provide additional sorting for the group. For example, in selected embodiments the Kiosk can accept mail delivered to a company address and provide additional sorting by “Mail Stop” for the group of employees.

As discussed above, in selected embodiments an imaging system can be used to track one or more items associated with an item management system. For example, there are many situations inside of a physical plant, warehouse, or work site where assets need to be tracked individually for inventory, security, or location purposes. Assets may include physical items, such as inventory or equipment (including vehicles), as well as human personnel working in certain areas. In selected embodiments, asset tracking may be accomplished using any number of machine-readable identification systems, including bar codes, RFID tags or badges, OCR-readable labels or badges, GPS transponder, or any variety of other biometric scanners, security tags or badges. In the case of personnel, the identifiers may also include keyboards or other data input devices used by personnel to identify themselves to a security system and/or other types of devices carried by the personnel. For example, machine-readable identifiers can be used to locate something or someone, to count the passage of something or someone from one area to another, or to provide workers with access to specific security areas. Video imaging systems or devices can also be used track items in an item management system and/or used in conjunction with various other identifiers (e.g., machine-readable identifiers) to track items.

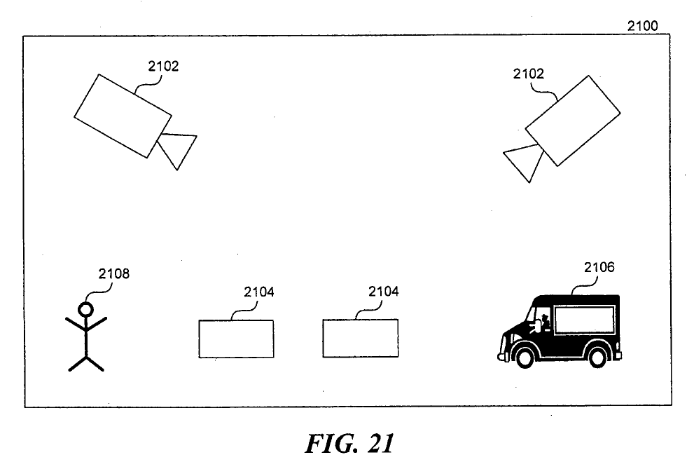

For example, FIG. 21 is a partially schematic illustration of an imaging system used to track items 2104 in an environment 2100, such as a portion of an item management system. In FIG. 21, the video imaging system includes two imaging devices 2102 positioned to track (e.g., video track) one or more items 2104 as the item(s) 2104 are moved within the environment 2100. In FIG. 21, the environment can also include multiple portions, such as the area surrounding the items 2104 and other things, such as people 2108 and equipment 2106 (e.g., including vehicles and machinery). Accordingly, in certain embodiments the imaging devices 2102 can be positioned to image other portions of the environment, for example, portions of the environment proximate to a selected item 2104. In selected embodiments the imaging devices can be operably coupled to a computing system (e.g., similar to the one shown in FIG. 4). In certain embodiments, the computing system can control, interface with, and/or store information from the imaging devices 2102. In selected embodiments, the imaging devices can interface with identifiers associated with the items to aid in tracking a selected item. As used herein, video imaging can include still or moving images that are recorded in/on a medium (e.g., film, a computer readable medium, etc.). In other embodiments the imaging system can include more or fewer imaging devices.

In selected embodiments the imaging devices can include imaging devices that operate in various frequency ranges, including visual light, infrared, and/or microwave. In certain embodiments, the imaging devices can provide continuous monitoring of a selected area or portion of the environment, and a selected item can be identified in or correlated with corresponding image(s) based on an identifier associated with the item. In other embodiments, the imaging devices can be in a standby mode and actuated when a selected identifier is detected in the vicinity of the imaging device. In still other embodiments, the detected position of an identifier can be used by the computing system to control an actuate that aims or focuses the imagining device toward a selected portion of the environment proximate to the position of the identifier.

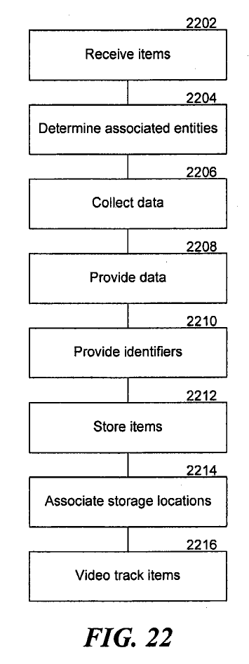

For example, as shown in FIG. 22, a method of tracking an item (e.g., a mail item in an item management system) can include receiving an item in a location remote from the entities (process portion 2202). The item can be associated with at least one of the remote entities. The method can further include determining which of the remote entities is associated with the item (process portion 2204), collecting data about the item (process portion 2206), and providing at least a portion of the data to at least one of the associated entities via a computer network (process portion 2208). The method can still further include providing a unique identifier with the item (process portion 2210), storing the item in a discrete storage location (process portion 2212), and associating the discrete storage location with the identifier of the item (process portion 2214). The method can yet further include video tracking a movement of the item using one or more video imaging devices (process portion 2216).

As discussed above, in selected embodiments video tracking can include using the associated identifier to identify the image of the item on video imagery captured by the one or more video imaging devices, aiming at least one of the one or more video imaging devices based on the identifier, and/or determining a time associated with the movement of the item. Additionally, as discussed above, video tracking can include capturing one or more video images of the environment proximate to the physical item. In selected embodiments the imaging system can allow an operator, client, or customer to create “movie documentaries” of an item's location and movement in a facility, work site, or other area by querying a computer system coupled to the imaging system with a selected time range and the identity of a selected identifier (e.g., an asset-tracking identification number associated with a barcode or RFID tag). The computer system can then automatically stitch together segments of video in which the specific asset was detected during the time range being queried and create a “movie” of that asset's movements within the area.

For example, in certain embodiments the imaging system can be used to track an item as it moves throughout an area. In other embodiments, the imaging system can be used to track workers (or others) as they move through the area proximate to selected items and/or if they are carrying selected items. In still other embodiments the imaging system can provide data/images for a forensic review to determine how an item became lost or damaged, a forensic review to determine the circumstances around a physical injury, an altercation between workers, any other personal or interpersonal activity, and/or a forensic review to determine how a piece of a machine or equipment may have been damaged, stolen, altered, or moved.

In other embodiments, an imaging system can be used for other applications and/or have other advantages. For example, in certain embodiments an imaging system can be used in a customs warehouse and an owner of selected items can call up a forensic video of the items (e.g., via a computing system) to see that the items are properly stored and/or handled. In other embodiments, a customer of a document outsourcing operation can call up a forensic video to see that their documents were handled with appropriate security and confidentiality. In still other embodiments, the imaging system can provide information regarding a workman's compensation claim, security breaches, and/or suspected illegal activities (e.g., theft). In yet other embodiments, the imaging system can be used to study/assess the productivity of an automated process and/or of workers performing a process.

In still other embodiments, an imaging system can be used in a competitive sports arena application to review the performance of a specific athlete or vehicle carrying an item (e.g., a package) associated with an identifier. In selected embodiments, an imaging system can be used in a hospital, elder care facility, school, prison, and/or the like to review the movements of personnel or equipment or both. For example, in selected embodiments a person can carry an item associated with an identifier (e.g., a bracelet with an RFID device) and the identifier can be used to aid in video tracking the item and person carrying the item. In yet other embodiments, an imaging system can be used to video track the movement of a vehicle (e.g., a motor vehicle or aircraft) carrying an item associated with an identifier. For example, the item can include a package carrying an RFID device, transponder, satellite tracking or positioning device and/or a cell phone with an identification feature/device. In still other embodiments, luggage at an airport can include an identifier (e.g., a barcode and/or RFID tag) and an imaging system can be used to video track movement of luggage through the transportation infrastructure/system. In some cases, this video tracking can be used to determine where luggage is and/or how luggage was lost.

In selected embodiments, the imaging devices 2102, shown in FIG. 21, can include different types of imaging devices. For example, in selected embodiments a first imaging device can image visual light and a second imaging device can image infrared energy. A computing system operably coupled to the imaging devices can be used to superimpose multiple images with each other to enhance visual recognition and/or display the images separately.

Additionally, in selected embodiments the computing system can provide a time stamp so that an item can be video tracked with respect to time and location. This feature can be especially useful when tracking an item with several imaging devices that do not have over lapping field of views (e.g., where different imaging devices view different areas). Furthermore, the computing system can be used to process, store, and replay images associated with movement of an item. For example, in certain embodiments the computing system can process information to determine a position of an item using the captured image of the item, the location of the imaging device, the aiming of the imaging device, and/or other background images recorded by the imaging device (e.g., signage or other markings that can be used to visual identify selected locations). Additionally, in certain embodiments the video tracking data (e.g., imagery from the imaging device) can be combined with positional data obtained from the identifier (e.g., using a GPS device and/or triangulation on another type of identifier) to determine positioning. In still other embodiments, the computing system can include computer programs that can enhance images recorded by the imaging devices to provide better resolution and/or image interpretation.

A feature of some of the embodiments discussed above is that an item management system can efficiently store non-uniform items in a uniform structure, track the location of the items, and retrieve the items when needed. An advantage of this feature is that the system can save time and money when storing and managing items that have diverse physical characteristics. Another advantage of some of the embodiments discussed above is that physical items can be managed remotely by a user. For example, items can be physically received, stored, tracked, and/or processed at a location remote from the user and the user can electronically review and manage the items via a network. An advantage of this feature is that it provides consistent access to important information regardless of the location and/or schedule of the user. Additionally, when an item management system includes a remote mail system, this feature can provide users with a single address that never changes. Another feature of some of the embodiments described above is that various items can be received and stored in a secure environment. This can be especially useful for document management systems and remote mail systems. Yet another feature of some of the embodiments discussed above is that an imaging system can be used for video tracking. An advantage of this feature is that in some case it can increase the efficiency, operability, and/or security of an item management system.

From the foregoing, it will be appreciated that specific embodiments of the invention have been described herein for purposes of illustration, but that various modifications may be made without deviating from the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/We claim:

1. A method of tracking a mail item, comprising:
receiving a physical mail item in a location remote from remote entities, the mail item being associated with at least one of the remote entities;
determining which of the remote entities is associated with the mail item;
collecting data about the mail item;
providing at least a portion of the data to at least one of the associated remote entities via a computer network;
providing a unique identifier with the mail item;
storing the mail item in a discrete storage location;
associating the discrete storage location with the identifier of the physical mail item; and
video tracking a movement of the mail item using one or more video imaging devices.

2. The method of claim 1 wherein video tracking includes at least one of:
identifying the image of the mail item on video imagery captured by the one or more video imaging devices via the identifier;
aiming at least one of the one or more video imaging devices based on the identifier; and
determining a time associated with the movement of the mail item.

3. The method of claim 1 wherein video tracking includes capturing one or more video images of the environment proximate to the physical item.

4. The method of claim 1 wherein the identifier is at least one of a barcode and an RFID tag.

5. A method of tracking an item, comprising:
receiving a physical item in a location remote from at least one of a plurality of remote entities, the item being associated with the at least one of the remote entities, the item having an identifier;
storing the item in a discrete storage location;
associating the discrete storage location with the identifier of the physical item; and
video tracking a movement of the physical item using one or more video imaging devices.

6. The method of claim 5 wherein video tracking includes identifying the image of the physical item on video imagery captured by the one or more video imaging devices via the identifier.

7. The method of claim 5 wherein video tracking includes aiming at least one of the one or more video imaging devices based on the identifier.

8. The method of claim 5 wherein video tracking includes capturing one or more video images of the environment proximate to the physical item.

9. The method of claim 5 wherein the physical item includes a physical mail item.

10. The method of claim 5 wherein the method further includes determining which of the remote entities is associated with the item based on the identifier.

11. The method of claim 5 wherein the method further includes:
determining which of the remote entities is associated with the item based on the identifier;
collecting data about the item; and
providing at least a portion of the data to the associated entity via a computer network.

12. The method of claim 5 wherein the identifier is at least one of a barcode and an RFID tag.

13. The method of claim 5 wherein video tracking includes determining a time associated with the movement of the physical item.

14. A method of delivering mail items at a facility, comprising:
receiving a physical mail item at the facility where multiple entities receive mail items, the mail item being associated with at least one of the entities;
determining which of the entities are associated with the mail item;
providing a unique identifier with the mail item;
storing the mail item in a discrete storage location; and
associating the discrete storage location with the identifier of the physical mail item, the mail item being retrievable by an associated entity.

15. The method of claim 14, further comprising:
collecting data about the mail item; and
providing at least a portion of the data to an associated entity via a computer network.

16. The method of claim 14, further comprising:
receiving a request to provide the physical mail item to an associated entity;
identifying the physical mail item via the identifier; and
providing the physical mail item to the associated entity.

17. The method of claim 14, further comprising:
receiving instructions for disposition of the mail item; and
taking at least one action to carry out the instructions.

18. A method of sorting mail items at a postal facility, comprising:
receiving multiple mail items at the postal facility, each mail item being associated with at least one remote entity;
determining which of the remote entities are associated with each mail item;
providing a unique identifier with each mail item; and
storing the mail items in discrete storage locations associated with the provided identifiers, the mail item being retrievable for delivery to the associated remote entities.

19. The method of claim 18, further comprising:
collecting data about the mail item; and
providing at least a portion of the data to the at least one associated entity via a computer network.

20. The method of claim 18, further comprising:
removing the mail items from the storage locations; and
delivering the mail items to the associated remote entities.
